(19) United States
(12) Patent Application Publication
(10) Pub. No.: US 2019/0182059 A1
(43) Pub. Date: Jun. 13, 2019

(54) UTILIZING MACHINE LEARNING FROM EXPOSED AND NON-EXPOSED USER RECALL TO IMPROVE DIGITAL CONTENT DISTRIBUTION

(71) Applicant: Facebook, Inc., Menlo Park, CA (US)

(72) Inventors: Ahmad Mamdouh Abdou, London (GB); Peter Herbrich, London (GB); Damien Lefortier, London (GB); Daniel Kristopher Harvey, London (GB); George Kamps, London (GB)

(21) Appl. No.: 15/839,315

(22) Filed: Dec. 12, 2017

(51) Int. Cl. H04L 12/18; G06N 99/00; G06N 7/00

(52) U.S. Cl. CPC H04L 12/18; H04L 67/20; G06N 7/005; G06N 99/005

(57) ABSTRACT

One or more embodiments of the present disclosure involve training and utilizing a recall machine learning model to predict recall lift on a per-user basis with respect to digital content items. For example, systems described herein train a recall machine learning model based on poll responses from exposed users and non-exposed users with regard to sample digital content. In particular, the systems described herein train the recall machine learning model to output recall lift scores for a target user based on an assumption that the target user has been exposed to digital content and an assumption that the target user has not been exposed to the digital content. The systems described herein further involve delivering digital content in accordance with the recall lift score.

### BACKGROUND

Advancements in computing devices and network technology have led to a variety of innovations in providing targeted digital content across computer networks. For example, online digital content systems are now able to serve targeted digital content to users spanning the globe almost instantaneously. Indeed, whether in entertainment, employment, or advertising, modern online digital content systems are able to provide instantaneous digital content to thousands of users via various types of client devices.

Despite these advances, however, conventional digital content systems continue to suffer from a number of disadvantages. For example, while conventional systems can selectively distribute digital content campaigns to a limited target audience or, alternatively, a larger general audience, these systems often experience difficulty optimizing a campaign. For example, conventional systems are often unable to accurately predict how many users will recall viewing or otherwise interacting with a received digital content item. As a result, many conventional systems are often unable to communicate with target users in a way to achieve a particular campaign objective, or combination of objectives. To illustrate, conventional systems are often unable to implement a campaign to ensure that the target number of users will receive and remember the digital content distributed during the campaign.

These and other problems exist with regard to conventional digital content distribution systems.

### BRIEF SUMMARY

This disclosure describes one or more embodiments of methods, non-transitory computer readable media, and systems that solve the foregoing problems in addition to providing other benefits. While this summary refers to systems for simplicity, the summary also applies to certain disclosed methods and non-transitory computer readable media. One or more embodiments of the present disclosure provide systems that utilize a machine learning model to accurately determine whether a target user will recall exposure to delivered digital content. The disclosed systems deliver sample digital content to an exposed group of users without delivering the sample digital content to a non-exposed group of users. The disclosed systems further analyze poll responses from the exposed and non-exposed groups of users indicating whether the various users recall viewing the sample digital content. The disclosed systems then train a recall machine learning model to output a recall lift score on a per-user basis based on differences between the poll responses from the different groups of users.

In particular, the disclosed systems predict recall lift for individual users by training a recall machine learning model to predict recall lift on a per-user basis. In training the recall machine learning model, the disclosed systems train a first machine learning model to predict recall based on an assumption that a user has been exposed to digital content. In addition, the disclosed systems jointly train a second machine learning model to predict recall based on an assumption that the user has not been exposed to digital content. By jointly training the first and second machine learning models, the disclosed systems more accurately predict recall lift with less training data, thereby reducing costs associated with collecting training data while utilizing fewer processing resources to train and apply the recall machine learning model.

Further, by training a recall machine learning model to predict recall lift on a per-user basis, the disclosed systems determine recall lift without substantially limiting a target audience. For example, by training a recall machine learning model to predict recall lift based on multiple assumptions for the same user, the disclosed systems determine recall lift without pre-emptively identifying a group of holdout users who do not receive the target digital content. In this way, the disclosed systems expand the potential audience for target digital content, thereby increasing effectiveness for a digital content campaign.

Additional features and advantages of one or more embodiments of the present disclosure will be set forth in the description that follows, and in part will be obvious from the description, or may be learned by the practice of such example embodiments.

### BRIEF DESCRIPTION OF THE DRAWINGS

The detailed description is described with reference to the accompanying drawings in which:

FIG. 1 illustrates a block diagram of an environment in which a recall prediction system is implemented in accordance with one or more embodiments;

FIG. 2 illustrates an example flow diagram of training a recall machine learning model in accordance with one or more embodiments;

FIG. 3 illustrates another example flow diagram of training a recall machine learning model in accordance with one or more embodiments;

FIG. 4 illustrates an example of utilizing a trained recall machine learning model to determine a recall lift score for a user in accordance with one or more embodiments;

FIG. 5 illustrates a table showing recall lift scores corresponding to respective users in accordance with one or more embodiments;

FIG. 6 illustrates a sequence diagram of interactions between devices of the recall prediction system in accordance with one or more embodiments;

FIG. 7 illustrates a schematic diagram of an example recall prediction system implemented on a server device in accordance with one or more embodiments;

FIG. 8 illustrates a flow diagram of an example series of acts for training a recall machine learning model in accordance with one or more embodiments;

FIG. 9 illustrates a block diagram of an example computing device in accordance with one or more embodiments;

FIG. 10 illustrates a block diagram of an example network environment of a social networking system in accordance with one or more embodiments; and

FIG. 11 illustrates a social graph in accordance with one or more embodiments.

### DETAILED DESCRIPTION

This disclosure describes one or more embodiments of a recall prediction system that trains and utilizes a recall machine learning model to predict recall lift on a per-user basis. In particular, the recall prediction system can train and utilize a recall machine learning model to determine whether a user will remember receiving, viewing, or otherwise experiencing a digital content item over a period or range of time (e.g., two days). In one or more embodiments, the recall prediction system collects training data including poll responses from a combination of users known to have received digital content (e.g., exposed users) and users who have not received the digital content (e.g., non-exposed users). Based on the polling results, the recall prediction system trains a recall machine learning model to output a recall probability or recall lift based on differences between the polling results of the exposed users and the polling results of the non-exposed users. In one or more embodiments, the recall prediction system utilizes the trained recall machine learning model to predict recall lift on a per-user basis to more accurately predict recall rates of target users.

To illustrate, as mentioned above, the recall prediction system trains the recall machine learning model based on a combination of poll responses from exposed users and non-exposed users. For example, in one or more embodiments, the recall prediction system collects sample data including poll responses from a plurality of users of a networking system (e.g., a social networking system) indicating whether the users recall (e.g., remember viewing) sample digital content. For instance, the recall prediction system collects poll responses from exposed users and non-exposed users indicating whether the exposed and non-exposed users remember viewing, receiving, or otherwise experiencing the sample digital content.

Based on the responses, the recall prediction system trains a recall machine learning model to predict whether a user having a corresponding set of characteristics (e.g., profile data, interaction data, etc.) will recall exposure to a digital content item having a corresponding set of features. In particular, the recall prediction system can analyze poll responses from exposed users and poll responses from non-exposed users to determine recall rates between the different types of users with respect to different digital content campaigns. Moreover, the recall prediction system identifies and analyzes correlations between the poll responses, user characteristics, and features of the sample digital content to identify trends of recall rates and recall lift with respect to the polled users from the different polling groups (e.g., exposed groups, non-exposed groups). Based on the poll responses and associated data, the recall prediction system can train a recall machine learning model to predict whether individual users having a corresponding set of characteristics will recall digital content items having a corresponding set of features, or to predict a recall lift resulting from exposure to the digital content items.

As will be described in further detail below, the recall prediction system can train the recall machine learning model by jointly training different machine learning models based on the poll responses of the respective groups of sample users. For example, in one or more embodiments, the recall prediction system trains a first machine learning model to output predicted recall rates for exposed users. Similarly, the recall prediction system can train a second machine learning model to predict recall rates for non-exposed users. The recall prediction system can further utilize training results from both of the first machine learning model (e.g., exposed machine learning model) and the second machine learning model (e.g., non-exposed machine learning model) to train the recall machine learning model to output a recall lift score based on a difference between the predicted recall rates of the exposed and non-exposed users. In one or more embodiments, the recall prediction system more accurately trains the recall machine learning model by jointly and simultaneously training the exposed machine learning model and non-exposed machine learning model, as will be described in further detail below.

Utilizing the trained recall machine learning model, the recall prediction system can determine a recall lift score or other value for individual users. In one or more embodiments, the recall prediction system determines a recall lift score for a target user by generating recall predictions for the target user based on assumptions that the user is an exposed user and a non-exposed user. For example, in one or more embodiments, the recall prediction system utilizes the recall machine learning model to determine a first recall probability based on an assumption that the target user has been exposed to a digital content item. The recall prediction system further utilizes the recall machine learning model to determine a second recall probability based on an assumption that the target user has not been exposed to the digital content item. Further, the recall prediction system utilizes the recall machine learning model to determine a recall lift score based on the difference in recall probabilities under the different assumptions.

The recall prediction system can similarly determine recall lift scores for any number of users of a networking system with respect to a target digital content item. Based on the recall lift scores, the recall prediction system can accurately predict a number of users from a target group of users of the networking system who will remember receiving, viewing, or otherwise experiencing the target digital content. In one or more embodiments, the recall prediction system utilizes the recall machine learning model to determine recall lift scores for a plurality of users and identifies, based on the recall list scores, a subset of co-users whose combined recall lift scores add up to a target number of users who will recall receiving, viewing, or otherwise experiencing the target digital content. In one or more embodiments, the recall prediction system can provide the target digital content to the identified subset of co-users in accordance with the combined recall lift scores.

The recall prediction system provides several advantages over conventional content distribution systems. For example, the recall prediction system jointly trains discrete machine learning models within the recall machine learning model to determine recall rates for exposed users and non-exposed users, respectively. By training the exposed and non-exposed machine learning models jointly, the recall prediction system more accurately trains the recall machine learning model using less training data than conventional systems for training machine learning models. Thus, the recall prediction system can train the recall machine learning model while preserving processing power and cutting down on poll fatigue among users of the networking system.

In addition, the recall prediction system utilizes the trained machine learning model to determine lift recall on a per-user basis in real-time. For example, by training a machine learning model to determine recall lift on a per-user basis, the recall prediction system can determine recall lift for any number of users without withholding distribution to a holdout group, thereby reducing a total number of eligible target users for a digital content campaign. In addition, by determining recall lift in real-time for a digital content campaign, the recall prediction system determines recall lift for a group of target users without delay caused as a result of waiting for polling results to come in with respect to collecting poll responses from sample users polled with respect to the digital content campaign.

Moreover, as will be described in further detail below, in one or more embodiments, the recall prediction system utilizes capabilities of third-party machine learning models to more efficiently train the machine learning model for determining the recall lift for individual users. For example, in one or more embodiments, the recall prediction system receives an identification of a set of user characteristics having a threshold correlation to recall lift, thereby enabling the recall prediction system to train the machine learning model without considering superfluous user characteristics and by leveraging prior machine learning models trained based on the set of user characteristics. In this way, the recall prediction system further preserves computing resources by training the machine learning model using fewer variables (e.g., user characteristics) and without collecting as much data.

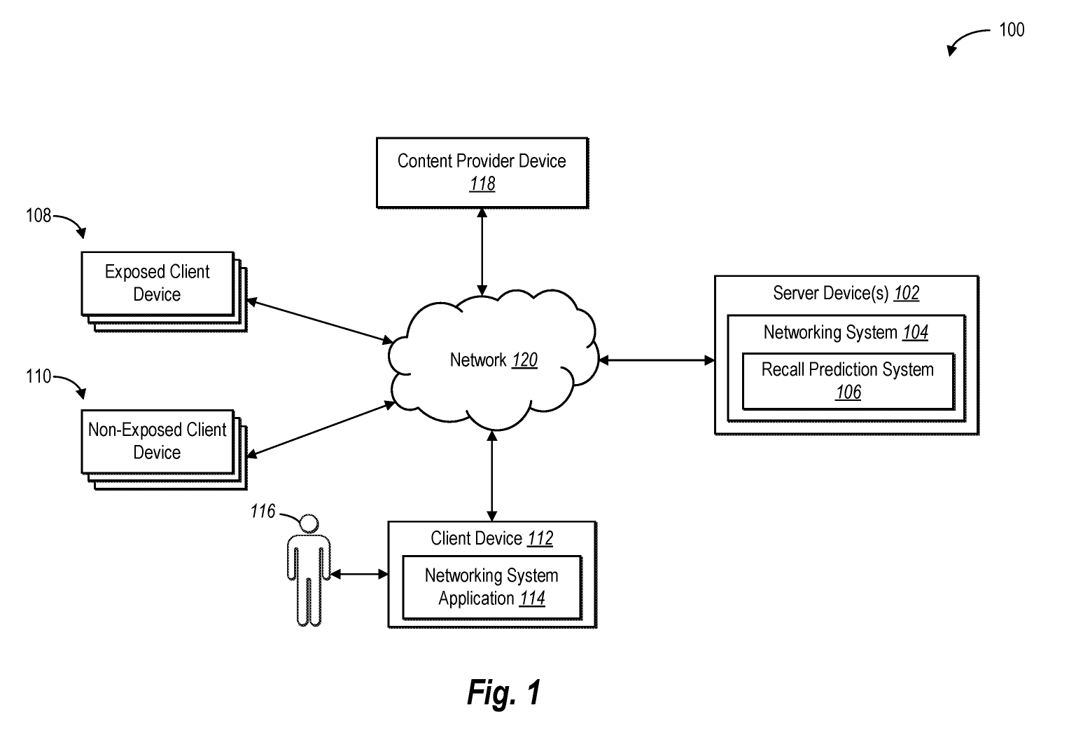

More detail regarding the recall prediction system will now be provided with reference to the figures. For example, FIG. 1 illustrates a schematic diagram of an example environment 100 for implementing a recall prediction system 106 in accordance with one or more embodiments. An overview of the recall prediction system 106 is described in relation to FIG. 1. Thereafter, a more detailed description of the components and processes of the recall prediction system 106 is provided in relation to the subsequent figures.

As illustrated in FIG. 1, the environment 100 includes server device(s) 102 that includes a networking system 104, which further includes the recall prediction system 106. The environment 100 further includes exposed client devices 108 and non-exposed client devices 110. In addition, the environment 100 includes a client device 112 (associated with a user 116) that includes a networking system application 114 thereon. In one or more embodiments, some or all of the exposed client devices 108 and non-exposed client devices 110 include a similar networking system application thereon. As further shown in FIG. 1, the environment 100 includes a content provider device 118. In one or more embodiments, the recall prediction system 106, including various features and functionalities described herein, may be implemented, at least in part, on the client device 112 and/or content provider device 118. Nonetheless, for the sake of explanation, one or more embodiments described herein relate to a recall prediction system 106 implemented on the server device(s) 102.

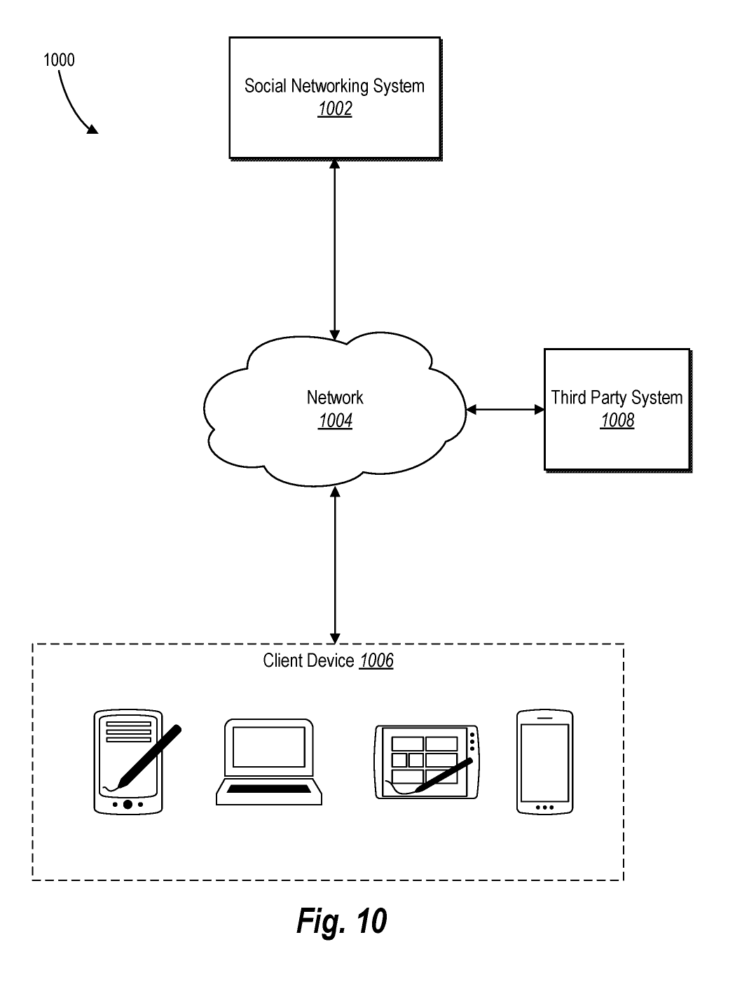

As shown in FIG. 1, each of the server device(s) 102, exposed client devices 108, non-exposed client devices 110, client device 112, and content provider device 118 can communicate over a network 120. The network 120 may include one or multiple networks and may use one or more communication platforms or technologies suitable for transmitting data. In one or more embodiments, the network 120 includes the Internet or World Wide Web. In addition, or as an alternative, the network 120 can include various other types of networks that use various communication technologies and protocols. Additional details relating to the network 120 are explained below in reference to FIG. 10.

Although FIG. 1 illustrates a particular number and arrangement of devices, it will be understood that the environment 100 can include any number of devices, including any number of server devices 102, exposed client devices 108, non-exposed client devices 110, client devices 112, and/or content provider devices 118. Moreover, one or more of the devices may directly communicate with the server device(s) 102 or via an alternative communication network, bypassing the network 120.

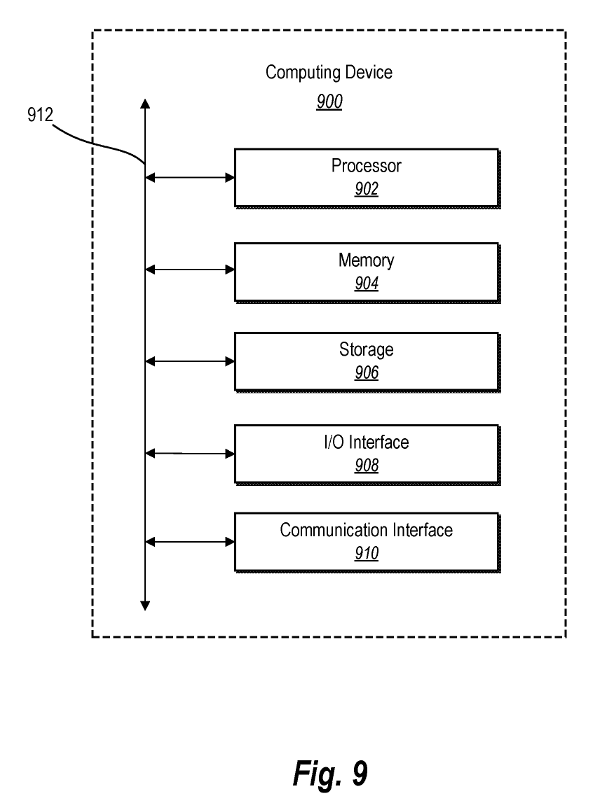

In addition, the devices of the environment may refer to various types of computing devices. For example, one or more of the devices may include a mobile device such as a mobile telephone, a smartphone, a PDA, a tablet, or a laptop. Additionally, or alternatively, one or more of the devices may include a non-mobile device such as a desktop computer, a server, or another type of computing device. Additional detail with regard to different types of computing devices is described in reference to FIG. 9.

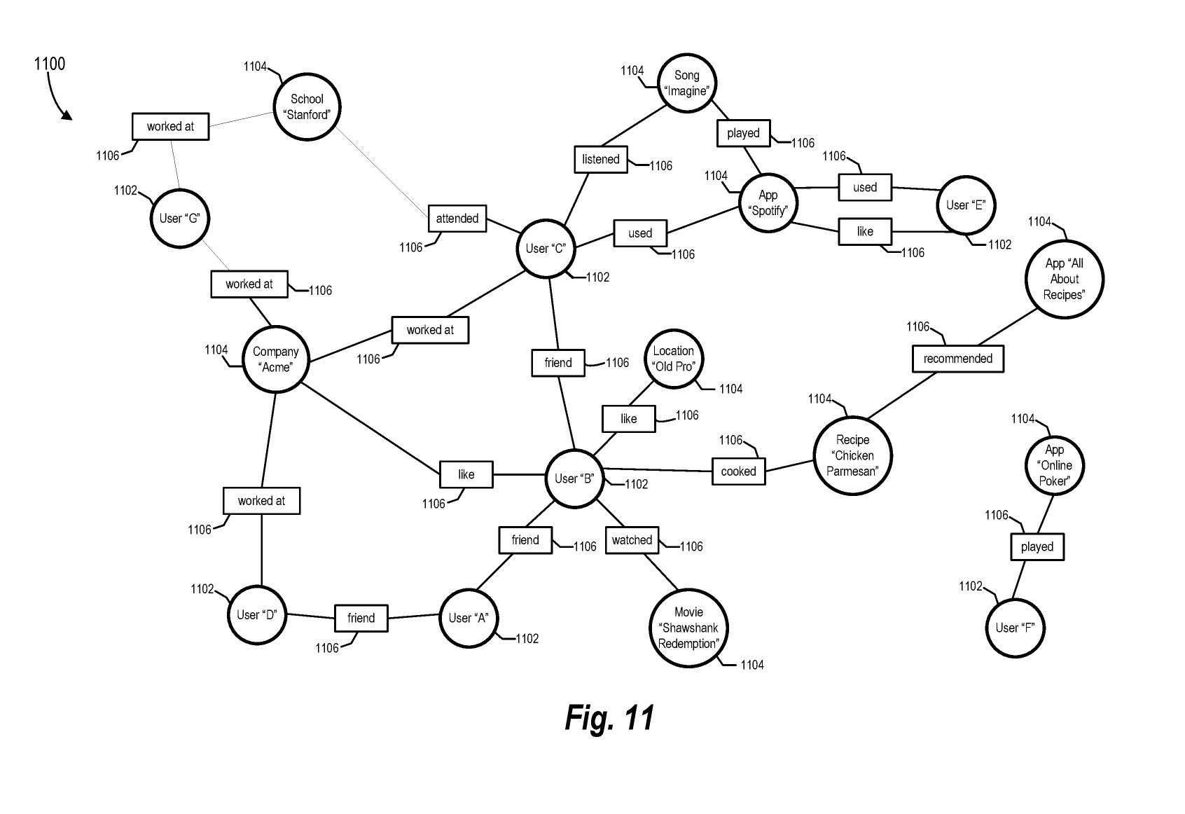

Further, the networking system 104 can refer to various types of networking systems including, for example, a social networking system, an electronic messaging system, or other type of networking system over which a community of users and co-users can share and access digital content. As such, while one or more examples described herein refer specifically to a social networking system, it will be understood that features and functionality described in connection with a social networking system can similarly apply to other types of networking systems. Additional detail with regard to the networking system 104, and particularly an example social networking system, is described below in connection with FIGS. 10-11.

In addition, in one or more embodiments, the networking system application 114 (e.g., a social networking system application and/or electronic messaging application) refers to a software application associated with the networking system 104. In one or more embodiments, the networking system application 114 provides and controls various features and functionality on the client device 112 and enables the user 116 to share and receive digital content from one or more devices of the environment 100. In one or more embodiments, the networking system application 114 refers to a native or hybrid application installed on a respective computing device. Alternatively, in one or more embodiments the networking system application 114 refers to a web browser used to access the networking system 104 (e.g., a website associated with the networking system 104 provided via a web browser on a respective computing device). In addition, while not shown in FIG. 1, some or all of the exposed client devices 108, non-exposed client devices 110, and content provider device 118 include a networking system application similar to the networking system application 114 on the client device 112.

As an overview, the recall prediction system 106 trains a recall machine learning model to accurately predict a recall lift score for a user 116 of a client device 112 and distributes content to the user 116 in accordance with the predicted recall lift score. In particular, as will be described in further detail below, the recall prediction system 106 collects poll responses from the exposed client devices 108 and non-exposed client devices 110 and trains a recall machine learning model based on the poll responses. In addition, the recall prediction system 106 utilizes the recall machine learning model to determine a recall lift score for the user 116 of the client device 112 and determines whether to provide target content to the user 116 in accordance with the recall lift score.

As used herein, a “digital content item” or “digital content” refers to a defined portion of digital data (e.g., a data file) including, but not limited to, digital images, digital video files, digital audio files, and/or folders that include one or more digital content items. In one or more embodiments described herein, digital content refers to a digital image or other digital media provided to one or more co-users of the networking system 104 by way of corresponding computing devices. In some embodiments, digital content item refers to an advertisement. Digital content can refer interchangeably to sample digital content and/or target digital content. As used herein, “sample digital content” refers to digital content provided to sample users by way of exposed client devices 108 associated with poll responses used to train a machine learning model. In addition, “target digital content” refers to digital content provided to a target user (e.g., user 116) of a corresponding computing device (e.g., client device 112) based on one or more outputs of the trained machine learning model.

As used herein, a “user” refers to an individual, company, business, group, or other entity who interacts with digital content and/or the networking system 104 by way of a client device. For example, a user can include a member or subscriber of a social networking system (e.g., a social networking system that includes or implements the recall prediction system 106). In one or more embodiments described herein, a user may refer to a target user (e.g., user within a target audience for a digital content item). Alternatively, in one or more embodiments, a user may refer to a sample user who provides training data (e.g., poll responses).

As shown in FIG. 1, the environment 100 includes exposed client devices 108 and non-exposed client devices 110 corresponding to exposed users and non-exposed users, respectively. In particular, in one or more embodiments, the recall prediction system 106 collects training data for training a recall machine learning model by providing sample digital content to exposed client devices 108 to be viewed or otherwise experienced by associated exposed users. In addition, the recall prediction system 106 polls sample users of the networking system 104 including users of the exposed client devices 108 (e.g., exposed users) and users of the non-exposed client devices 110 (e.g., non-exposed users) to determine how many of the sample users recall the sample digital content. In response, the recall prediction system 106 receives poll responses from the exposed client devices 108 and non-exposed client devices 110 indicating whether the exposed users and non-exposed users recall the sample digital content.

As used herein, “exposed users” and “non-exposed users” refer to users of the networking system 104 who provide poll responses indicating whether the respective users recall a sample digital content item. In particular, an exposed user refers to a user who has received, viewed, listened to, interacted with, or otherwise experienced sample digital content (e.g., as part of a digital content campaign). Alternatively, a non-exposed user refers to a user who has not received, viewed, listened to, interacted with, or otherwise experienced the sample digital content (e.g., as part of the same digital content campaign).

As mentioned above, a user may recall or not recall a digital content item. In particular, as used herein, a user who “recalls” digital content refers to a user (e.g., exposed or non-exposed user) who remembers receiving, viewing, hearing, interacting with, or otherwise experiencing digital content within a predetermined period of time. For example, in one or more embodiments, a sample user who recalls a sample digital content item refers to an exposed or non-exposed user who indicates within a poll response that they remember receiving or viewing the sample digital content item within a two-day window (e.g., 4-48 hours) of allegedly receiving the sample digital content item. While one or more embodiments described herein refer to “recalling users” who have received and remember viewing the received sample digital content item, “recalling users” can similarly refer to users who have not received the sample digital content item, but who nonetheless provide a poll response indicating that they remember receiving or viewing the sample digital content item.

In addition to collecting the poll responses from the sample users, the recall prediction system 106 associates user characteristics and features of the sample digital content with the poll responses. Based on this received information (e.g., training data), the recall prediction system 106 can train a recall machine learning model to determine whether a given user having a set of characteristics will recall viewing a digital content item having a set of corresponding features. In particular, as will be described in further detail below, the recall prediction system 106 can train a recall machine learning model to determine a recall lift for users of the networking system 104 indicating a likelihood (e.g., a probability) that the users will recall digital content having a corresponding set of features.

As mentioned above, in one or more embodiments, the recall prediction system 106 trains one or more machine learning models to individually or collectively output a recall lift score for individual users of the networking system 104. As used herein, a “machine learning model” refers to a computer representation that can be tuned (e.g., trained) based on inputs to approximate unknown functions. In particular, the term “machine-learning model” can include a model that utilizes algorithms to learn from, and make predictions on, known data by analyzing the known data to learn to generate outputs that reflect patterns and attributes of the known data. For instance, a machine-learning model can include but is not limited to a neural network (e.g., a convolutional neural network or deep learning), decision tree, association rule learning, inductive logic programming, support vector learning, Bayesian network, regression-based model, principal component analysis, or a combination thereof.

In one or more embodiments, the recall prediction system 106 trains a machine learning model with training data. As used herein, the term “training data” refers to information utilized to train (e.g., tune or teach) a machine learning model. For example, the recall prediction system 106 can utilize user characteristics from a number of polled users including, by way of example, user profile data (e.g., a social networking profile), a history of interactions (e.g., tracked interactions) in connection with sample digital content items, and a history of poll responses indicating recall of different sample digital content items. Training data can further include features of corresponding digital content items including, for example, specific products, brands, types of digital content (e.g., images, videos, audio files), and other information associated with the digital content items.

Using the trained recall machine learning model, the recall prediction system 106 can determine a recall lift score for the user 116 of the client device 112. In particular, using the recall machine learning model, the recall prediction system 106 can determine a first recall probability based on an assumption that the user 116 has recently viewed (or otherwise experienced) a digital content item. In addition, the recall prediction system 106 can determine a second recall probability based on an assumption that the user 116 has not recently viewed the digital content item. The recall prediction system 106 can further determine a recall lift score for the user 116 based on a difference between the first recall probability and the second recall probability.

The recall prediction system 106 can further cooperate with a content provider device 118 to provide digital content to a number of users of the networking system 104 in accordance with recall lift scores for various users of the networking system 104. For example, in one or more embodiments, the content provider device 118 provides a target number of recalling users to the recall prediction system 106. In particular, the target number of recalling users corresponds to a number of users of the networking system 104 that a merchant, advertiser, or other entity wants to remember receiving and viewing a digital content item within, for example, two days of delivery. The recall prediction system 106 can identify a group of co-users (e.g., including the user 116 of the client device 112) having a combined recall lift score equal to the received target number of recalling users. The recall prediction system 106 can further deliver the digital content item to the group of co-users in accordance with the recall lift values. Alternatively, in one or more embodiments, the recall prediction system 106 provides the content provider device 118 information that enables the content provider device 118 to provide the digital content to the identified group of co-users.

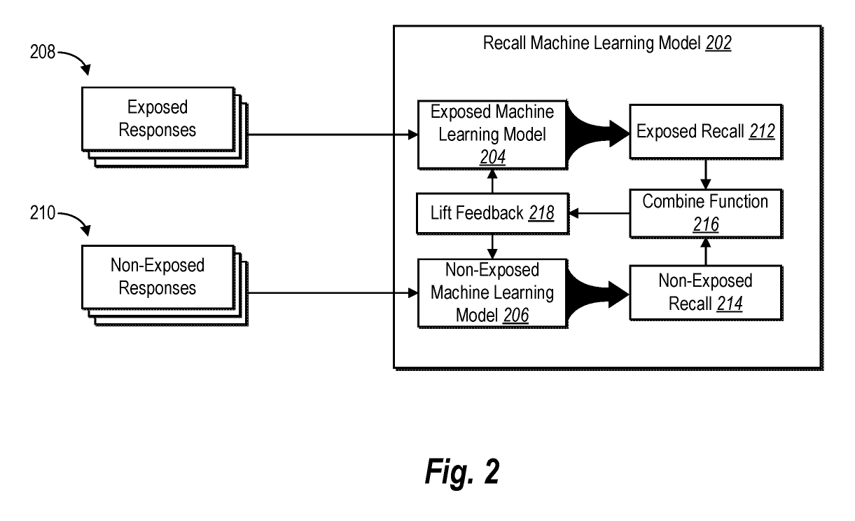

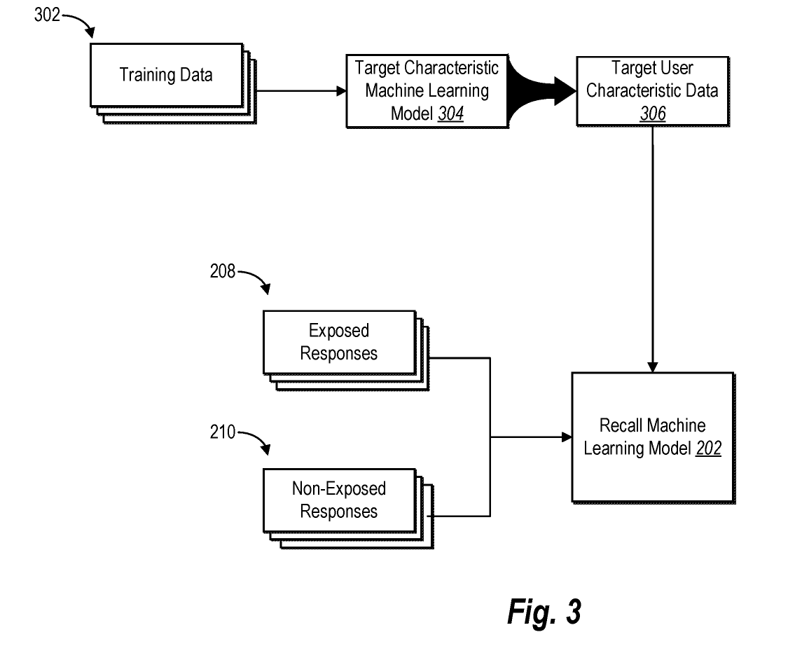

Additional detail will now be given with respect to training the recall machine learning model to output a recall lift score in accordance with one or more embodiments. In particular, FIGS. 2-3 illustrate example flow diagrams that show features and functionality of the recall prediction system 106 with respect to training a recall machine learning model. In particular, FIG. 2 shows an example embodiment in which the recall prediction system 106 trains a recall machine learning model by jointly training an exposed machine learning model and a non-exposed machine learning model. Further, FIG. 3 shows an example embodiment in which the recall prediction system 106 trains a recall machine learning model by utilizing a third-party machine learning model to identify inputs that facilitate a more effective training process of the recall machine learning model.

As mentioned above, and as shown in FIG. 2, the recall prediction system 106 trains a recall machine learning model 202 by jointly training an exposed machine learning model 204 and a non-exposed machine learning model 206. In particular, the recall prediction system 106 receives and provides exposed responses 208 including poll responses from the exposed client devices 108 and non-exposed responses 210 including poll responses from the non-exposed client devices 110 as input to the recall machine learning model 202. More specifically, the exposed responses 208 include poll responses indicating whether exposed users recall one or more sample digital content items. In addition, the non-exposed responses 210 include poll responses indicating whether non-exposed users recall one or more sample digital content items.

In addition to the poll responses, the recall prediction system 106 receives and provides data associated with the corresponding poll responses 208, 210 as input to the recall machine learning model 202. In particular, in one or more embodiments, the recall machine learning model 202 receives user characteristics of the users associated with the poll responses including, for example, user profile data (e.g., from a social networking profile) and a history of user interactions with respect to the networking system 104. In addition, in one or more embodiments, the recall machine learning model 202 receives data associated with features of the sample digital content referred to by the respective polling questions. By way of example, the features of the sample digital content can include brand information, product information, and information about the sample digital content (e.g., image data, audio data, video data, etc.).

As shown in FIG. 2, the recall prediction system 106 trains the exposed machine learning model 204 to output an exposed recall probability 212 based on the exposed responses 208 and associated data (e.g., user characteristics, digital content features). In particular, based on the exposed responses 208 and associated data, the recall prediction system 106 trains the exposed machine learning model 204 to predict a probability that a given user exposed to a digital content item will recall the digital content item within a predetermined period of time (e.g., two days). Accordingly, the recall prediction system 106 trains the exposed machine learning model 204 to output an exposed recall probability 212 corresponding to a probability of recall for a given user having a set of user characteristics when exposed to a digital content item having a set of corresponding features.

As further shown in FIG. 2, the recall prediction system 106 trains the non-exposed machine learning model 206 to output a non-exposed recall probability 214 based on the non-exposed responses 210 and associated data. In particular, based on the non-exposed responses 210 and associated data, the recall prediction system 106 trains the non-exposed machine learning model 206 to predict a probability that a given user who has not been exposed to a digital content item will nonetheless recall the digital content item within the predetermined period of time. Accordingly, the recall prediction system 106 trains the non-exposed machine learning model 206 to output a non-exposed recall probability 214 corresponding to a probability of recall for a given user having a set of user characteristics when asked about exposure to a digital content item having a set of corresponding features where the user has not been exposed to the digital content item.

In each instance of the exposed machine learning model 204 and the non-exposed machine learning model 206, the recall prediction system 106 identifies correlations between user characteristics, digital content features, and poll responses. In addition, the machine learning models 204, 206 learn one or more algorithms or functions to minimize loss between the poll responses 208, 210 and corresponding user characteristics and digital content features. Accordingly, the recall prediction system 106 trains the exposed machine learning model 204 to output an exposed recall probability 212 for any user with respect to a corresponding digital content item based on the learned functions and correlations from the exposed responses 208. Further, the recall prediction system 106 similarly trains the non-exposed machine learning model 206 to output a non-exposed recall probability 214 for any user with respect to corresponding digital content based on the learned functions and identified correlations from the non-exposed responses 210.

In one or more embodiments, the recall prediction system 106 utilizes a similar or identical process to train the exposed machine learning model 204 and the non-exposed machine learning model 206. For example, in one or more embodiments, both the exposed machine learning model 204 and the non-exposed machine learning model 206 include a neural network having a similar structure of layers trained collectively to output the recall probabilities 212, 214.

Alternatively, in one or more embodiments, the recall prediction system 106 trains the machine learning models 204, 206 having different structures that more accurately predict recall probabilities from the different sample sets of training data. As an example, the exposed machine learning model 204 may include a neural network while the non-exposed machine learning model 206 includes a regression-based learning model or decision tree(s).

As further shown in FIG. 2, the recall machine learning model 202 includes a combiner function 216 that combines the exposed recall probability 212 and the non-exposed recall probability 214 in accordance with one or more embodiments described herein. For example, in one or more embodiments, the combiner function 216 combines the probabilities by determining a difference between the exposed probability 212 and the non-exposed probability 214 to generate a recall lift score. Accordingly, the combiner function 216 can account for response bias from the exposed responses 208 by subtracting false recall responses from the non-exposed responses 210. In one or more embodiments, the combiner function 216 combines the exposed recall probability 212 and the non-exposed recall probability 214 using a function other than a simple difference between the exposed recall probability 212 and the non-exposed recall probability 214.

Moreover, as shown in FIG. 2, the recall prediction system 106 provides lift feedback 218 based on a value of the combiner function 216 to jointly train the exposed machine learning model 204 and the non-exposed machine learning model 206. As a result, in training the respective machine learning models 204, 206, the machine learning models 204, 206 can further consider the combined result of exposed responses 208 and non-exposed responses 210 in learning algorithms and functions that accurately reflect the trends and correlations identified within the training data.

Accordingly, the recall prediction system 106 can train the recall machine learning model 202 to output a recall lift score for a given user having a set of user characteristics and with respect to a digital content item having a corresponding set of features. In addition, as shown in FIG. 2, the recall prediction system 106 can train the recall machine learning model 202 by jointly training the exposed machine learning model 204 and non-exposed machine learning model 206 to output respective recall probabilities 212, 214. By jointly training the exposed and non-exposed machine learning models 204, 206, the recall prediction system 106 trains the recall machine learning model 202 to output a recall lift score on a per-user basis under both assumptions that a given user has simultaneously been exposed and non-exposed to a target digital content item.

While one or more embodiments described herein refer generally to training a recall machine learning model 202 to be applied generally to users of the networking system 104, in one or more embodiments, the recall prediction system 106 trains a recall machine learning model 202 for a respective demographic or subset of users of the networking system 104. For example, the recall prediction system 106 can train a recall machine learning model in accordance with one or more embodiments described herein to determine recall lift scores for a limited demographic of users and/or users having a shared user characteristic. Accordingly, in one or more embodiments, the recall prediction system 106 trains multiple recall machine learning models to determine recall lift scores for different segments of users of the networking system 104.

In one or more embodiments, the recall prediction system 106 utilizes one or more additional machine learning models to further train the recall machine learning model 202 discussed above in connection with FIG. 2. For example, as shown in FIG. 3, the recall prediction system 106 trains the recall machine learning model 202 based on exposed responses 208 and non-exposed responses 210 and associated data as discussed above in connection with FIG. 2. In addition, as shown in FIG. 3, in one or more embodiments, the recall prediction system 106 trains the recall machine learning model 202 based on additional training data 302.

In particular, in one or more embodiments, the recall prediction system 106 utilizes a target characteristic machine learning model 304 to identify target user characteristic data 306 including user characteristics having a threshold correlation to recall rates of users of the networking system 104. For example, as an alternative to analyzing the exposed responses 208 and non-exposed responses 210 in view of every possible user characteristic associated with the users who provide the poll responses 208, 210, the recall prediction system 106 can substantially limit the amount of analysis and training by utilizing a target characteristic machine learning model 304 that learns target user characteristics known to have a higher correlation (e.g., a threshold correlation) to recall rates than less important user characteristics. For example, in one or more embodiments, the target user characteristic data 306 includes a subset of user characteristics from determined to have a significant correlation (e.g., a threshold correlation) to recall rates. In this way, the recall prediction system 106 can train the recall machine learning model 202 (as well as the individual exposed and non-exposed machine learning models 204, 206) based on, for example, a few dozen user characteristics and/or digital content features rather than thousands of potential user characteristics and/or digital content features.

As shown in FIG. 3, the target characteristic machine learning model 304 can receive training data 302 including user data, digital content features, and associated recall responses. Based on the training data 302, the recall prediction system 106 or other system on a third-party device can train the target characteristic machine learning model 304 to learn and output target user characteristic data 306 including user characteristics that have a significant impact on recall rates of exposed users and/or non-exposed users. As further shown in FIG. 3, the recall machine learning model 202 can receive the target user characteristic data 306 as another input in addition to the poll responses 208, 210 and learn algorithms and/or functions to accurately predict a recall lift score for a given user having a set of user characteristics corresponding to the target user characteristic data 306.

As mentioned above, in one or more embodiments, the target user characteristic data 306 includes an identified set of user characteristics that the target characteristic machine learning model 304 learns has a significant correlation (e.g., a threshold correlation) to recall rates of polled users. In one or more embodiments, target characteristic machine learning model 304 outputs a plurality of user characteristics to be used by each of the exposed machine learning model 204 and the non-exposed machine learning model 206 in training the recall machine learning model 202 to output recall lift scores. Alternatively, in one or more embodiments, the target characteristic machine learning model 304 outputs a first set of user characteristics having a significant correlation to recall rates for exposed users and a second set of user characteristics having a significant correlation to recall rates for non-exposed users. Accordingly, when analyzing characteristics of a user to determine a recall lift score, the recall machine learning model 202 can analyze different characteristics of a user of interest for determining respective recall probabilities (e.g., exposed recall probability and non-exposed recall probability) and outputting a recall lift score.

While FIG. 3 shows an example in which a target characteristic machine learning model 304 outputs target user characteristic data 306 as an input for training the recall machine learning model 202, in one or more embodiments, the recall prediction system 106 utilizes one or more additional machine learning models to similarly identify key features of digital content that correlates with recall probabilities. As an example, in one or more embodiments, the recall prediction system 106 utilizes a third-party machine learning model that outputs a combination of features of digital content having a strong correlation to recall rates of exposed and non-exposed users. In one or more embodiments, the third-party machine learning model outputs different features of digital content items for training the exposed machine learning model 204 and non-exposed machine learning model 206.

In one or more embodiments, the recall prediction system 106 trains the target characteristic machine learning model 304 based on the sample data including exposed responses 208 and non-exposed responses 210. Alternatively, in one or more embodiments, the recall prediction system 106 utilizes a third-party machine learning model trained using different training data from the exposed responses 208, non-exposed responses 210, and associated data used to train the recall machine learning model 202. Accordingly, in one or more embodiments, the recall prediction system 106 transfers learning from other models that have learned from more examples and training data than is available to the recall prediction system 106.

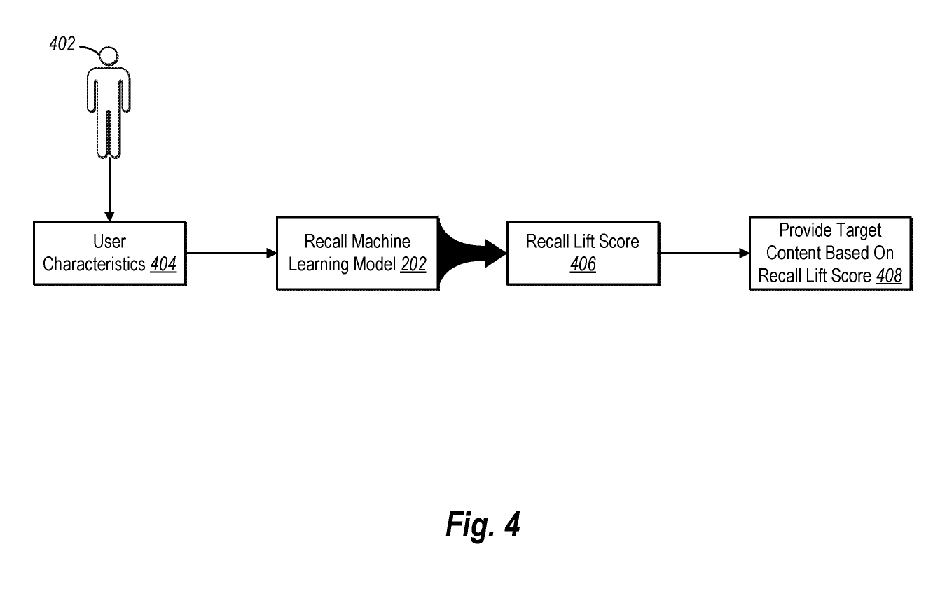

Once trained, the recall prediction system 106 can utilize the machine learning model 202 to determine recall lift scores and provide target digital content to one or more target users in accordance with the determined recall lift scores. For example, as shown in FIG. 4, the recall prediction system 106 utilizes a trained recall machine learning model 202 to determine a recall lift score 406 for a user 402 having corresponding user characteristics 404 and further based on features of a target digital content item. While FIG. 4 shows one example in which the recall prediction system 106 utilizes the trained recall machine learning model 202 to determine a recall lift score 406 for a single user 402, the recall prediction system 106 can similarly utilize the recall machine learning model 202 to determine recall lift scores for any number of users of the networking system 104. In addition, in one or more embodiments, the recall prediction system 106 utilizes the trained recall machine learning model to determine recall lift scores for a user with respect to multiple target digital content items.

In determining the recall lift score 406 for the user 402, the recall machine learning model 202 can determine an exposed recall probability using an exposed machine learning model 204 based on an assumption that the user 402 has been exposed to a digital content item. In addition, the recall machine learning model 202 can determine a non-exposed recall probability using a non-exposed machine learning model 206 based on an assumption that the user 402 has not been exposed to the digital content item. In one or more embodiments, the recall machine learning model 202 outputs the recall lift score 406 by determining the difference between the exposed recall probability for the user 402 and the non-exposed recall probability for the user 402.

As mentioned above, in one or more embodiments, the recall prediction system 106 trains the exposed machine learning model 204 and non-exposed machine learning model 206 using different sets of user characteristics. Accordingly, in one or more embodiments, the recall machine learning model 202 determines an exposed recall probability for the user 402 based on an analysis of a first subset of the user characteristics 404 associated with the user 402 while determining the non-exposed recall probability based on an analysis of a second subset of the user characteristics 404 associated with the user 402. Moreover, in one or more embodiments, the recall machine learning model 202 outputs a recall lift score based on analysis of a subset of the user characteristics 404 as indicated by target user characteristic data 306 determined by a third-party machine learning model (e.g., the target characteristics machine learning model 304).

As further shown in FIG. 4, the recall prediction system 106 can provide 408 target digital content based on the recall lift score output from the recall machine learning model 202. As an example, in one or more embodiments, the recall prediction system 106 provides target digital content to users having a recall lift score that exceeds a threshold recall lift score. In this way, the recall prediction system 106 optimizes delivery of target digital content to a group of co-users having a high likelihood of recalling the delivered target digital content.

As another example, in one or more embodiments, the recall prediction system 106 identifies a group of co-users of the networking system 104 for target digital content delivery based on a combined recall lift score of the group of co-users. For instance, in one or more embodiments, the recall prediction system 106 receives a target number of recalling users that a marketer, merchant, or other entity associated with a content provider device 118 wants to remember (e.g., recall) receiving a target digital content item. Based on the target digital content (e.g., features of the target digital content), the recall prediction system 106 utilizes the recall machine learning model 202 to determine recall lift scores for a plurality of users and identifies, from the plurality of users, a subset of users (e.g., a target group) having a combined recall lift score equal to the received target number of recalling users. Based on the combined recall lift score of the target group of users, the recall prediction system 106 can deliver the target digital content and accurately predict that a target number of the group of users will recall the target digital content within a predetermined period of time (e.g., two days).

In one or more embodiments, the recall prediction system 106 utilizes the trained recall machine learning model 202 to test effectiveness between different digital content items and/or digital content campaigns. For example, the recall prediction system 106 can conduct an A/B test between two different digital content items on a per-user basis to determine which of the two different digital content items will result in a higher recall lift score for the corresponding user. Accordingly, rather than testing different groups of similar users with respect to the different digital content items, the recall prediction system 106 can utilize the trained recall machine learning model 202 to perform A/B testing on a per-user basis for any number of users. In this way, the recall prediction system 106 can determine whether a first or second digital content item for an associated digital content campaign would be more effective with respect to a given user.

Moreover, in one or more embodiments, the recall prediction system 106 can increase recall lift among a plurality of target users for a digital content campaign by selectively delivering different digital content items from the digital content campaign based on generated recall lift scores for the plurality of target users generated using the recall machine learning model 202. For example, similar to the AB testing mentioned above, the recall prediction system 106 can identify a digital content item from multiple digital content items for a corresponding brand, product, or common digital content campaign predicted to yield higher recall lift for each of a plurality of target users. The recall prediction system 106 can utilize the recall machine learning model 202 to generate a recall lift score for the plurality of target users and selectively deliver the digital content item associated with the higher lift score for each of the plurality of target users, thereby increasing recall lift across the plurality of target users.

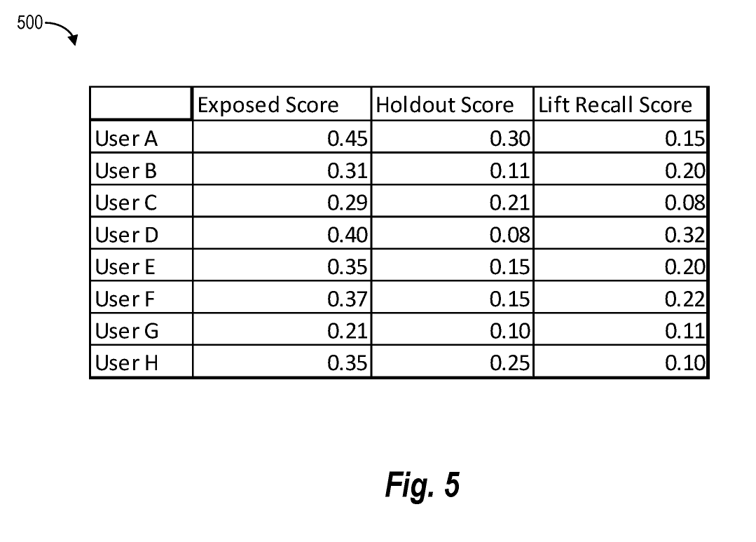

FIG. 5 illustrates an example score table 500 including recall values for corresponding users (Users A-H) of the networking system 104. In particular, as shown in FIG. 5, the score table 500 includes a column of exposed scores, non-exposed scores, and recall lift scores for each of the users shown in the score table 500. For example, the exposed scores include exposed probability scores determined using a trained exposed machine learning model 204. In addition, the non-exposed scores include non-exposed probability scores determined using a trained non-exposed machine learning model 206. Further, in one or more embodiments, the recall prediction system 106 determines the recall lift scores by calculating a difference between the exposed scores and the non-exposed scores, as shown in FIG. 5.

In one or more embodiments, the recall prediction system 106 generates the score table 500 or other data structure including recall lift scores for any number of users of the networking system 104. Using the score table 500, the recall prediction system 106 can identify a group of co-users of the networking system 104 having a combined recall lift score equal to a target number of recalling users. For example, as mentioned above, in one or more embodiments, the recall prediction system 106 receives a target number of recall users from a content provider device 118. Based on the target number, the recall prediction system 106 analyzes the score table 500 and identifies a group of co-users whose combined (summed) lift recall scores equal the target number which corresponds to a number of users expected to accurately recall receiving and viewing a digital content item.

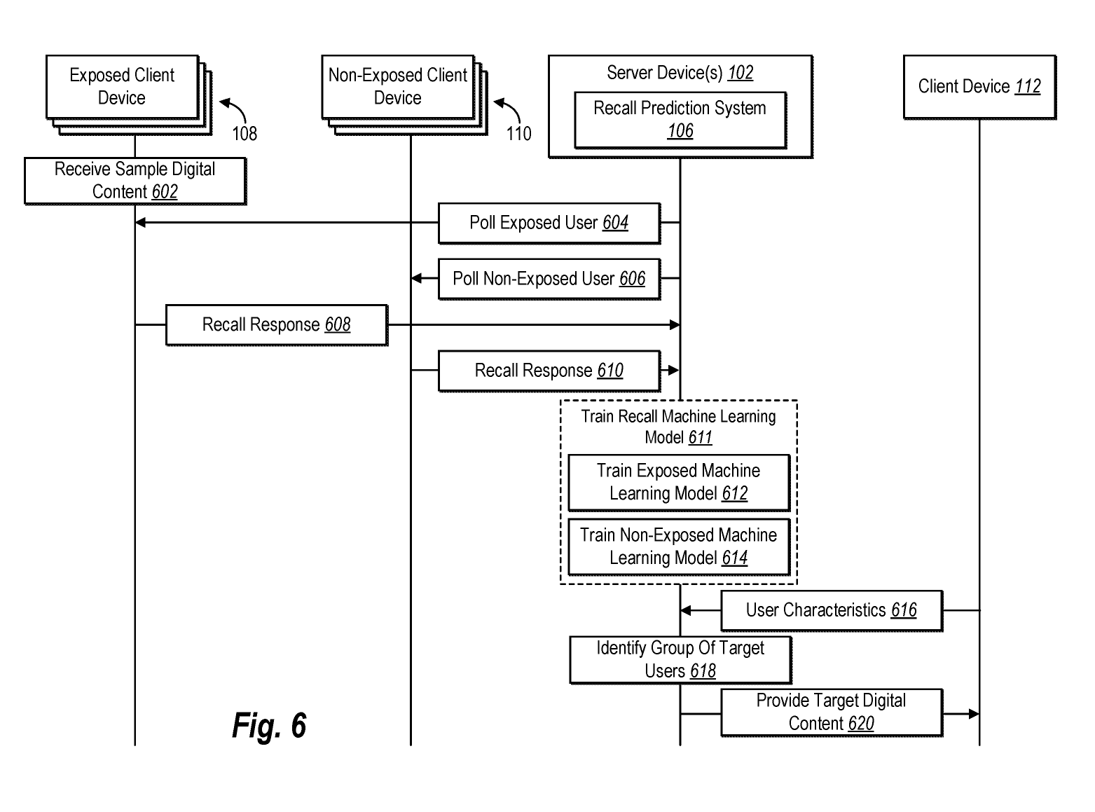

FIG. 6 illustrates a sequence diagram of interactions between devices of the environment 100 in accordance with one or more embodiments described herein. In particular, FIG. 6 illustrates an example embodiment for collecting training data from exposed client devices 108 and non-exposed client devices 110, training a recall machine learning model 202, and providing target digital content to a client device 112 in accordance with a recall lift score generated by the recall machine learning model 202.

As illustrated in FIG. 6, the exposed client devices 108 receive 602 sample digital content. In one or more embodiments, the exposed client devices 108 receive the sample digital content from the recall prediction system 106 via the server device(s) 102. Alternatively, in one or more embodiments, the exposed client devices 108 receive the sample digital content from a content provider device 118 or other third-party server device that provides digital content to client devices. In one or more embodiments, the sample digital content refers to any digital content associated with a respective digital content campaign. For example, a digital content campaign can refer to one or more related digital content items. For instance, a digital content campaign can include multiple images and/or videos associated with the same brand or product.

In addition, while FIGS. 1-6 illustrate example embodiments in which exposed client devices 108 and non-exposed client devices 110 refer exclusively to exposed and/or non-exposed devices with reference to providing training data to the recall prediction system 106, it will be understood that a client device can refer to an exposed client device in connection with a first digital content campaign and a non-exposed client device in connection with a second digital content campaign (or in connection with different digital content items). For example, a first client device may receive a first sample digital content item, resulting in the first client device being an exposed client device with regard to the first sample digital content item (or corresponding digital content campaign). However, the first client device may not receive a second sample digital content item, resulting in the first client device being a non-exposed client device with regard to the second sample digital content item (or corresponding digital content campaign). Accordingly, when collecting sample data including poll responses, it will be understood that the exposed client devices 108 and non-exposed client devices 110 refer to client devices with respect to specific sample digital content items and/or specific digital content campaigns.

As shown in FIG. 6, the recall prediction system 106 polls 604 the exposed client devices 108. In addition, the recall prediction system 106 polls 606 the non-exposed client devices 110. In one or more embodiments, the recall prediction system 106 polls the exposed and non-exposed client devices 108, 110 by sending a poll to the client devices 108, 110 asking users of the client devices 108, 110 if they recall (e.g., remember viewing) one or more sample digital content items.

In one or more embodiments, polling the exposed and/or non-exposed users further includes identifying poll-eligible users of the networking system 104. For example, rather than polling all users of the networking system 104 generally, the recall prediction system 106 can identify users that provide more useful or otherwise focused recall responses. For instance, the recall prediction system 106 can identify users having certain baseline characteristics (e.g., 18+ years old, minimum daily budget, threshold history of interactions with the networking system 104, language). In one or more embodiments, the recall prediction system 106 may identify poll-eligible users by identifying users of a target demographic to further focus the training data. For example, the recall prediction system 106 may exclusively poll users based on a common interest in a brand, product, location, or other user characteristic.

In response to the polling, the exposed client devices 108 provide 608 recall responses indicating whether or not the users of the respective exposed client devices 108 recall the one or more sample digital content items. In addition, the non-exposed client devices 110 similarly provide 610 recall responses indicating whether or not the users of the respective non-exposed client devices 110 recall the one or more sample digital content items.

As mentioned above, in one or more embodiments, the recall prediction system 106 additionally receives user data associated with the poll respondents. For example, in one or more embodiments, the exposed client devices 108 and non-exposed client devices 110 provide user information in conjunction with the recall responses. Alternatively, in one or more embodiments, the recall prediction system 106 identifies user profile data or other user information associated with the respective users already available to the recall prediction system 106. In one or more embodiments, the recall prediction system 106 tracks user interactions with respect to digital content to further collect user characteristic data associated with the various exposed and non-exposed users.

As further shown in FIG. 6, the recall prediction system 106 trains 611 the recall machine learning model 202 based on the received recall responses. In particular, as described above, the recall prediction system 106 trains the recall machine learning model 202 based on recall responses in connection with associated user characteristics data (e.g., user profile data, history of user interactions, etc.) and features of the sample digital content associated with the recall responses. As described in one or more embodiments herein, the recall prediction system 106 trains the recall machine learning model to determine a recall lift score for a given user having a set of user characteristics for a corresponding digital content item (or digital content campaign).

As shown in FIG. 6, training the recall machine learning model includes training 612 an exposed machine learning model 204. In particular, the recall prediction system 106 trains the exposed machine learning model 204 based on the received recall responses from the exposed client devices 108. In one or more embodiments, the recall prediction system 106 trains the exposed machine learning model 204 to determine a recall probability for a given user having a set of user characteristics for a target digital content item based on an assumption that the given user has received, viewed, or otherwise been exposed to the target digital content item.

As further shown, training the recall machine learning model includes training 614 a non-exposed machine learning model 206. In particular, the recall prediction system 106 trains the non-exposed machine learning model 206 based on the received recall responses from the non-exposed client devices 110. In one or more embodiments, the recall prediction system 106 trains the non-exposed machine learning model 206 to determine a recall probability for a given user having a set of user characteristics for a target digital content item based on an assumption that the given user has not received, viewed, or otherwise been exposed to the target digital content item.

In one or more embodiments, the recall prediction system 106 trains the recall machine learning model 202 by jointly training the exposed machine learning model 204 and the non-exposed machine learning model 206. For example, as described above in connection with FIG. 2, in one or more embodiments, the recall prediction system 106 further fine-tunes or otherwise trains the exposed machine learning model 204 and non-exposed machine learning model 206 using respective outputs from the respective machine learning models 204, 206. For instance, in one or more embodiments, the recall prediction system 106 provides feedback data including combined training results of the exposed and non-exposed machine learning models 204, 206.

As mentioned above, the recall prediction system 106 trains the recall machine learning model 202 to output a recall lift score on a per-user basis. In one or more embodiments, the recall prediction system 106 predicts the recall lift score by fine-tuning one or more algorithms and functions for determining an exposed recall rate, non-exposed recall rate, and resulting recall lift score. In addition, the recall prediction system 106 can fine-tune one or more weights with respect to corresponding user characteristics and/or digital content features. For example, in one or more embodiments, the recall prediction system 106 determines weighting factors for individual digital content features and/or user characteristics that the recall prediction system 106 determines to be more or less determinative to exposed and non-exposed recall rates as well as a resulting recall lift score.

As further shown in FIG. 6, the recall prediction system 106 receives user characteristics 616 from the client device 112. In particular, the recall prediction system 106 receives user characteristics associated with a user of the client device 112. In one or more embodiments, the recall prediction system 106 collects user characteristics by identifying profile data and/or other user information maintained on the server device(s) 102 associated with the user of the client device 112. In addition, in one or more embodiments, the recall prediction system 106 collects user characteristics by identifying a history of interactions with respect to the networking system 104 and/or digital content items provided to the user via the networking system 104.

In one or more embodiments, the recall prediction system 106 collects user characteristics 616 by tracking one or more user interactions with respect to a target digital content item. For example, at the time of impression (e.g., initial exposure to a target digital content item), the recall prediction system 106 can track information including a duration of time that a target digital content item was displayed via a graphical user interface of the client device 112, whether or not the user interacted with the displayed target digital content item, or other information associated with an impression of the user with respect to the target digital content item.

As further shown in FIG. 6, the recall prediction system 106 identifies 618 a group of target users for delivery of a target digital content item. In one or more embodiments, the recall prediction system 106 identifies the group of target users by applying the trained recall machine learning model 202 to determine recall lift scores for any number of users of the networking system 104. The recall prediction system 106 further identifies the group of target users by identifying a group of co-users of the networking system having a combined recall lift score that equals a target number of recalling users. In one or more embodiments, the recall prediction system 106 identifies the group of target users based on a number of target users provided by a content provider device 118 based on a number of recalling users a marketer, advertiser, or other entity desires to view and remember a target digital content item.

As further shown in FIG. 6, once the group of target users is identified, the recall prediction system 106 provides 620 target digital content to the client device 112. In particular, the recall prediction system 106 provides the target digital content to the client device 112 based on determining that the user of the client device 112 is part of the identified group of target users. The recall prediction system 106 can provide the target digital content item(s) via a newsfeed of the networking system 104, by way of direct communication (e.g., email, instant message, social networking message) to the client device 112, or other communication platform. Alternatively, in one or more embodiments, the content provider device 118 directly provides the target digital content to the client device 112.

In one or more embodiments, the recall prediction system 106 periodically updates the machine learning model(s) based on additional training data. For example, in one or more embodiments, the recall prediction system 106 polls one or more additional sample users with respect to digital content campaigns and fine-tunes the recall machine learning model 202 based on recall responses received from the additional sample users. In one or more embodiments, the recall prediction system 106 fine-tunes the recall machine learning model based on poll responses from both exposed and non-exposed sample users. As an alternative to additionally polling sample users, the recall prediction system 106 can receive additional input by way of one or more third-party machine learning models that provide one or more inputs that the recall prediction system 106 utilizes to fine-tune the recall machine learning model 202.

Moreover, because the recall prediction system 106 trains the recall machine learning model 202 based on user characteristics and identified digital content features across any number of digital content campaigns, the recall prediction system 106 can update the recall machine learning model by polling a very small sample of users across any number of digital content campaigns. For example, rather than polling a few digital content campaigns heavily, thereby causing polling fatigue and holding out a large number of potential target users for digital content providers, the recall prediction system 106 can train and update the recall machine learning model 202 without substantially effecting any one digital content campaign. In this way, the recall prediction system 106 stays calibrated over time without negatively impacting various digital content campaigns.

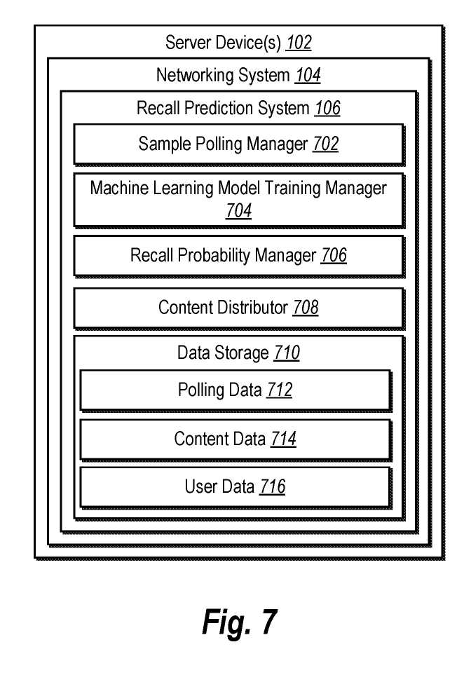

Turning now to FIG. 7, additional detail will be provided regarding components and capabilities of an example architecture for the recall prediction system 106 that may be implemented on the server device(s) 102, client device 112, content provider device 118, or a combination of one or more of the server device(s) 102, client device 112, and content provider device 118. In particular, FIG. 7 illustrates one implementation of the server device(s) 102 having similar features and functionality associated with one or more embodiments described above. For example, the recall prediction system 106 can provide features and functionality associated with training a recall machine learning model 202 to determine recall probabilities on a per-user basis and deliver target digital content in accordance with the determined recall probabilities.

As shown in FIG. 7, the server device(s) 102 includes a networking system 104. In one or more embodiments, the networking system 104 refers to a social networking system. The networking system 104 includes the recall prediction system 106, which includes a sample polling manager 702, machine learning model training manager 704, recall probability manager 706, and a content distributor 708. The recall prediction system 106 further includes a data storage 710, which includes polling data 712, content data 714, and user data 716.

In one or more embodiments, components of the recall prediction system 106 may, for example, be implemented as one or more stand-alone applications, as one or more modules of an application, as one or more plug-ins, as one or more library functions or functions that may be called by other applications (e.g., a web application), and/or as a cloud-computing model. In one or more embodiments, the recall prediction system 106 is implemented as an application provided to a content provider device 118 or as a remote service provided to the content provider device 118 by way of the networking system 104 implemented on the server device(s) 102.

In addition, while FIG. 7 shows an example embodiment in which the components 702-716 are implemented on the server device(s) 102, it will be understood that the components 701-718 may be implemented wholly or partially on the client device 112, the content provider device 118, one or more server device(s), or a combination thereof. In addition, while FIG. 7 shows that the data storage 710 is implemented entirely on the server device(s) 102, the information contained within the data storage 710 can be located within a corresponding data storage on the server device(s) 102 and/or stored collectively between data storages accessible to the client device 112, server device(s) 102, and/or the content provider device 118.

As shown in FIG. 7, the recall prediction system 106 includes a sample polling manager 702. In one or more embodiments, the sample polling manager 702 identifies exposed users and non-exposed users to poll in connection with sample digital content items. For example, in one or more embodiments, the sample polling manager 702 identifies poll-eligible users having a set of user characteristics associated with a particular goal for a digital content campaign. In addition, the sample polling manager 702 identifies a first set of users who have received, viewed, or otherwise been exposed to sample digital content items and a second set of users who have not received, viewed, or otherwise been exposed to the sample digital content items.

In addition to identifying exposed and non-exposed users, the sample polling manager 702 further polls the sample users (including both exposed and non-exposed users) by polling the sample users and asking whether the sample users recall the sample digital content. For example, the sample polling manager 702 sends a survey or other poll asking the sample users to indicate whether they remember receiving and/or viewing sample digital content.

In addition to collecting poll responses, the sample polling manager 702 further collects user characteristic information about the sample users as well as feature information about the sample digital content. For example, the sample polling manager 702 can collect user characteristic information including user profile data, a history of user interactions, and other information associated with the sample users. In addition, the sample polling manager 702 can identify or otherwise collect features about the sample digital content including associated brands, products, and other information associated with the sample digital content.

As further shown in FIG. 7, the recall prediction system 106 includes a machine learning model training manager 704. The machine learning model training manager 704 utilizes the information gathered by the sample polling manager 702 and trains a recall machine learning model 202 in accordance with one or more embodiments described herein. In particular, the machine learning model training manager 704 trains the recall machine learning model 202 to output recall probabilities (e.g., a recall lift score) for a given user in connection with a target digital content item based on user characteristics of the given user and corresponding features of the target digital content item.

In one or more embodiments, the machine learning model training manager 704 trains the recall machine learning model 202 by respectively training an exposed machine learning model 204 and a non-exposed machine learning model 206. For example, the machine learning model training manager 704 can train the exposed machine learning model 204 based on poll responses from exposed users. The machine learning model training manager 704 can further train the non-exposed machine learning model 206 based on poll responses from non-exposed users. In one or more embodiments, the machine learning model training manager 704 jointly trains the exposed and non-exposed machine learning models 204, 206 in accordance with one or more embodiments described above.

In addition, in one or more embodiments, the machine learning model training manager 704 utilizes transfer learning from one or more remote machine learning models. For example, in one or more embodiments, the machine learning model training manager 704 trains or otherwise utilizes third-party training of a machine learning model that identifies key user characteristics to focus on when training the recall machine learning model 202. As another example, in one or more embodiments, the machine learning model training manager 704 trains or otherwise utilizes third-party training of a machine learning model that identifies key features of digital content items to focus on when training the recall machine learning model 202.

As further shown in FIG. 7, the recall prediction system 106 includes a recall probability manager 706. In one or more embodiments, the recall probability manager 706 determines recall probabilities for users of the networking system 104. For example, the recall probability manager 706 can determine recall lift score for a given user having a corresponding set of user characteristics in connection with a target digital content item. In particular, the recall probability manager 706 can provide user characteristics of the user and feature characteristics of the target digital content item as input to the trained recall machine learning model 202 to determine a recall lift score. The recall probability manager 706 can similarly determine a recall lift score for any number of users of the networking system 104.

In one or more embodiments, the recall probability manager 706 similarly utilizes the recall machine learning model to determine a recall lift score for a given user with respect to more than one target digital content item. For example, the recall probability manager 706 can determine recall lift scores for respective target digital content items to determine which of the target digital content items will make a greater impression on a given user. In this way, the recall probability manager 706 can identify a target digital content item from a number of related digital content items (e.g., digital content items from the same campaign) most likely to result in recall for a given user.

As further shown in FIG. 7, the recall prediction system 106 includes a content distributor 708. The content distributor 708 utilizes the trained recall machine learning model 202 to identify one or more target users for distribution of target digital content. For example, in one or more embodiments, the content distributor 708 identifies users of the networking system having a recall lift score that exceeds a threshold lift score and distributes target digital content based on the recall lift score exceeding the threshold.

Alternatively, in one or more embodiments, the content distributor 708 utilizes the recall lift scores for a plurality of users to more accurately predict a number of target users who will recall viewing or otherwise experiencing target digital content. For example, in one or more embodiments, the content distributor 708 receives a target number of users associated with a number of users that a marketer, advertiser, or other entity hopes to provide target digital content and remember receiving the target digital content. Accordingly, in one or more embodiments, the content distributor 708 identifies a group of target users whose combined recall lift score equals or exceeds the target number, and distributes target digital content based on a prediction that a target number of the group of target users will recall the target digital content.

As further shown in FIG. 7, the recall prediction system 106 includes the data storage 710 including the polling data 712. The polling data 712 can refer to any information obtained when polling the sample users, including exposed users and non-exposed users. For example, the polling data 712 can include recall responses indicating whether the sample users recall sample digital content. In addition, the polling data 712 can include information about the sample users and information about the sample digital content.

As further shown, the data storage 710 includes content data 714. In accordance with one or more embodiments described above, the content data 714 can include any information about sample digital content and/or target digital content. For instance, the content data 714 can include features of the digital content including, by way of example, brand information, product information, and/or file information (e.g., image, video, audio information).

In addition, the data storage 710 includes user data 716. In accordance with one or more embodiments described above, the user data 716 can include any information about users of the networking system 104 including sample users (e.g., exposed and/or non-exposed users) and target users. For instance, the user data 716 can include user characteristics including, by way of example, user profile information, a history of user interactions, and other information that may be used to train the recall machine learning model 202 and/or determine a recall lift score for a corresponding user.

Each of the components 702-716 can comprise software, hardware, or both. For example, the components 702-716 can comprise one or more instructions stored on a computer-readable storage medium and executable by processors of one or more computing devices. When executed by the one or more processors, the computer-executable instructions of the recall prediction system 106 can cause a server device and/or client device to perform the methods described herein. Alternatively, the components 702-716 and their corresponding elements can comprise hardware, such as a special purpose processing device to perform a certain function or group of functions. Additionally, the components 702-716 can comprise a combination of computer-executable instructions and hardware.

Furthermore, the components 702-716 may, for example, be implemented as one or more operating system s, as one or more stand-alone applications, as one or more modules of an application, as one or more plug-ins, as one or more library functions or functions that may be called by other applications, and/or as a cloud-computing model. Thus, the components 702-716 may be implemented as a stand-alone application, such as a desktop or mobile application. Furthermore, the components 702-716 may be implemented as one or more web-based applications hosted on a remote server. The components 702-716 may also be implemented in a suit of mobile device applications or “apps.”

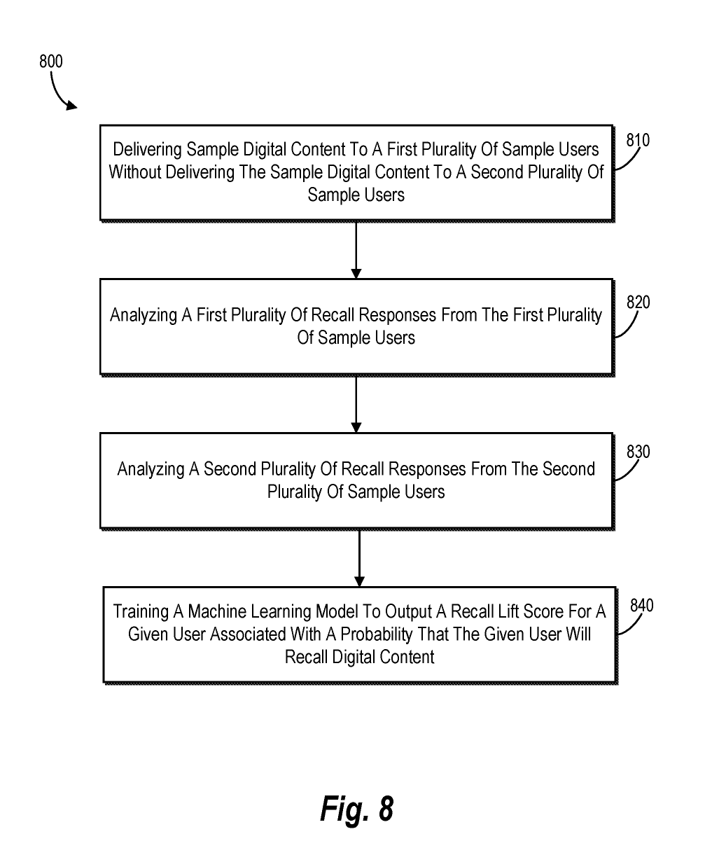

Turning now to FIG. 8, this figure illustrates a flowchart of a method 800 including a series of acts for training a recall machine learning model 202 and determining recall lift on a per-user basis. While FIG. 8 illustrates acts according to individual embodiments, alternative embodiments may omit, add to, reorder, and/or modify any of the acts shown in FIG. 8. The acts of FIG. 8 may be performed as part of a method. Alternatively, a non-transitory computer readable medium can comprise instructions, that when executed by one or more processors, cause a computing device to perform the acts of FIG. 8. In still further embodiments, a system can perform the acts of FIG. 8.

FIG. 8 illustrates a flowchart of an example method 800 for training a machine learning model to determine and output a recall lift score on a per-user basis based on received poll responses from both exposed and non-exposed sample users. For example, as shown in FIG. 8, the method 800 includes an act 810 of delivering sample digital content to a first plurality of sample users without delivering the sample digital content to a second plurality of sample users. In one or more embodiments, the act 810 includes delivering a sample digital content to a first plurality of sample users (e.g., exposed users) of a networking system 104 without delivering the sample digital content to a second plurality of sample users (e.g., non-exposed users) of the networking system 104.

In one or more embodiments, the method 800 includes generating a machine learning model (e.g., recall machine learning model 202) that outputs a lift recall score for a given user with respect to a target digital content item, the given user having a corresponding set of user characteristics. For instance, as shown in FIG. 8, the method 800 includes an act 820 of analyzing a first plurality of recall responses from the first plurality of sample users. In one or more embodiments, the act 820 includes analyzing a first plurality of poll responses from the first plurality of sample users of the networking system 104 indicating whether the first plurality of sample users recall (e.g., remember receiving, viewing, hearing, interacting with, or otherwise experiencing) the sample digital content. As further shown in FIG. 8, the method 800 includes an act 830 of analyzing a second plurality of recall responses from the second plurality of sample users. In one or more embodiments, the act 830 includes analyzing a second plurality of poll responses from the second plurality of sample users of the networking system 104 indicating whether the second plurality of sample users recall the sample digital content.

As further shown in FIG. 8, the method 800 includes an act 840 of training a machine learning model (e.g., recall machine learning model 202) to output a recall lift score for a given user associated with a probability that the given user will recall digital content. For example, in one or more embodiments, the act 840 includes training the machine learning model to output a recall lift score for the given user associated with a probability that the given user will recall the target digital content item based on a difference between recall rates of the first plurality of recall responses with respect to the sample digital content and recall rates of the second plurality of recall responses with respect to the sample digital content.

In one or more embodiments, training the machine learning model to output the recall lift score for the given user includes training a first machine learning model (e.g., exposed machine learning model 204) to generate a first predicted recall probability for the given user based on an assumption that the given user has been exposed to the sample digital content. In addition, in one or more embodiments, training the machine learning model to output the recall lift score for the given user includes training a second machine learning model (e.g., non-exposed machine learning model 206) to generate a second predicted recall probability for the given user based on an assumption that the given user has not been exposed to the sample digital content. In one or more embodiments, training the machine learning model includes jointly training the first machine learning model and the second machine learning model based on correlations between user characteristics of the first plurality of sample users and the second plurality of sampled users and associated differences between recall rates corresponding to the first plurality of sample users and recall rates corresponding to the second plurality of sample users.

In one or more embodiments, the method 800 further includes identifying a target number of users. In addition, the method 800 can include applying the machine learning model to a plurality of users of the networking system 104 to determine recall lift scores for the plurality of users corresponding to the target digital content item. Further, the method 800 can include identifying a group of co-users of the networking system 104 associated with recall lift scores having a sum equal to the target number of users. In one or more embodiments, the method 800 further includes providing the target digital content item to the target number of users by providing the target digital content item to the identified group of co-users associated with recall lift scores having the sum equal to the target number of users.

As mentioned above, the method 800 can include applying the machine learning model to a plurality of users of the networking system 104. In one or more embodiments, for each of the plurality of users, applying the machine learning model includes identifying a first recall probability based on an assumption that a user has been exposed to the target digital content item. In addition, applying the machine learning model can include identifying a second recall probability based on an assumption that the user has not been exposed to the target digital content item. Further, applying the machine learning model can include determining a recall lift score for the user based on a difference between the first recall probability and the second recall probability. In one or more embodiments, for each of the plurality of users, the method 800 includes identifying user characteristics comprising one or more of user profile characteristics, a history of impression actions with respect to previously viewed digital content, and one or more tracked interactions with respect to the target digital content item.

In one or more embodiments, the method 800 makes use of shared learning from one or more third-party machine learning models when generating the machine learning model. For example, in one or more embodiments, the method 800 includes leveraging a third-party machine learning model to determine a set of target user characteristics having a correlation to recall lift scores of users with respect to corresponding digital content. Further, in one or more embodiments, the method 800 includes training the machine learning model to output the recall lift score for the given user based on the identified set of target characteristics for the given user where the identified set of target user characteristics include a subset of the set of user characteristics. For example, the identified set of target characteristics can exclude one or more of a larger set of user characteristics. In one or more embodiments, the method 800 includes receiving different subsets of characteristics as input to the first and second machine learning models within the machine learning model for outputting the recall lift score.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. In one or more embodiments, the server device(s) 102, client devices 108-112, and content provider device 118 each comprise one or more computing devices in accordance with implementations of computing device 900. As shown by FIG. 9, the computing device can comprise a processor 902, a memory 904, a storage device 906, an I/O interface 908, and a communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other embodiments. Furthermore, in certain embodiments, a computing device 900 can include fewer components than those shown in FIG. 9. Components of computing device 900 shown in FIG. 9 will now be described in additional detail.

In particular embodiments, processor 902 includes hardware for executing instructions, such as those making up a computer program. As an example, and not by way of limitation, to execute instructions, processor 902 may retrieve (or fetch) the instructions from an internal register, an internal cache, memory 904, or storage device 906 and decode and execute them. In particular embodiments, processor 902 may include one or more internal caches for data, instructions, or addresses. As an example, and not by way of limitation, processor 902 may include one or more instruction caches, one or more data caches, and one or more translation lookaside buffers (TLBs). Instructions in the instruction caches may be copies of instructions in memory 904 or storage 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 904 may be internal or distributed memory.

Storage device 906 includes storage for storing data or instructions. As an example, and not by way of limitation, storage device 906 can comprise a non-transitory computer readable storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to the computing device 900. In particular embodiments, storage device 906 is non-volatile, solid-state memory. In other embodiments, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output driver's (e.g., display driver's), one or more audio speakers, and one or more audio driver's. In certain embodiments, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, in one or more embodiments, the networking system 104 is linked to and/or is implemented as a social networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example, and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in to a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia files to a user's profile page (e.g., timeline)” or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similar to events, the calendar entries may include times, dates, locations and identities of other users.

FIG. 10 illustrates an example network environment 1000 of a social-networking system. In particular embodiments, a social-networking system 1002 may comprise one or more data stores. In particular embodiments, the social-networking system 1002 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 1002 may comprise one or more computing devices (e.g., servers) hosting functionality directed to operation of the social-networking system 1002. A user of the social-networking system 1002 may access the social-networking system 1002 using a client device such as client device 1006. In particular embodiments, the client device 1006 can interact with the social-networking system 1002 through a network 1004.

The client device 1006 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1006 may access the social-networking system 1002.

While these methods, systems, and user interfaces utilize both publicly available information as well as information provided by users of the social-networking system, all use of such information is to be explicitly subject to all privacy settings of the involved users and the privacy policy of the social-networking system as a whole.

FIG. 11 illustrates example social graph 1100. In particular embodiments, social networking system 1002 may store one or more social graphs 1100 in one or more data stores. In particular embodiments, social graph 1100 may include multiple nodes—which may include multiple user nodes 1102 or multiple concept nodes 1104—and multiple edges 1106 connecting the nodes. Example social graph 1100 illustrated in FIG. 11 is shown, for didactic purposes, in a two-dimensional visual map representation. In particular embodiments, a social networking system 1002, client device 1006, or third-party system 1008 may access social graph 1100 and related social-graph information for suitable applications. The nodes and edges of social graph 1100 may be stored as data objects, for example, in a data store (such as a social-graph database). Such a data store may include one or more searchable or query able indexes of nodes or edges of social graph 1100.

In particular embodiments, a user node 1102 may correspond to a user of social networking system 1002. As an example, and not by way of limitation, a user may be an individual (human user), an entity (e.g., an enterprise, business, or third-party application), or a group (e.g., of individuals or entities) that interacts or communicates with or over social networking system 1002. In particular embodiments, when a user registers for an account with social networking system 1002, social networking system 1002 may create a user node 1102 corresponding to the user, and store the user node 1102 in one or more data stores. Users and user nodes 1102 described herein may, where appropriate, refer to registered users and user nodes 1102 associated with registered users. In addition, or as an alternative, users and user nodes 1102 described herein may, where appropriate, refer to users that have not registered with social networking system 1002. In particular embodiments, a user node 1102 may be associated with information provided by a user or information gathered by various systems, including social networking system 1002. As an example, and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 1104 may correspond to a concept. As an example and not by way of limitation, a concept may correspond to a place (such as, for example, a movie theater, restaurant, landmark, or city); a website (such as, for example, a website associated with social-network system 1002 or a third-party website associated with a web-application server); an entity (such as, for example, a person, business, group, sports team, or celebrity); a resource (such as, for example, an audio file, video file, digital photo, text file, structured document, or application) which may be located within social networking system 1002 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1104 may be associated with information of a concept provided by a user or information gathered by various systems, including social networking system 1002. As an example, and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1104 may be associated with one or more data objects corresponding to information associated with concept node 1104. In particular embodiments, a concept node 1104 may correspond to one or more webpages.

In particular embodiments, a node in social graph 1100 may represent or be represented by a webpage (which may be referred to as a “profile page”). Profile pages may be hosted by or accessible to social networking system 1002. Profile pages may also be hosted on third-party websites associated with a third-party system 1008. As an example, and not by way of limitation, a profile page corresponding to a particular external webpage may be the particular external webpage and the profile page may correspond to a particular concept node 1104. Profile pages may be viewable by all or a selected subset of other users. As an example, and not by way of limitation, a user node 1102 may have a corresponding user-profile page in which the corresponding user may add content, make declarations, or otherwise express himself or herself. As another example and not by way of limitation, a concept node 1104 may have a corresponding concept-profile page in which one or more users may add content, make declarations, or express themselves, particularly in relation to the concept corresponding to concept node 1104.

In particular embodiments, a concept node 1104 may represent a third-party webpage or resource hosted by a third-party system 1008. The third-party webpage or resource may include, among other elements, content, a selectable or other icon, or other inter-actable object (which may be implemented, for example, in JavaScript, AJAX, or PHP codes) representing an action or activity. As an example, and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 1006 to send to social networking system 1002 a message indicating the user's action. In response to the message, social networking system 1002 may create an edge (e.g., an “eat” edge) between a user node 1102 corresponding to the user and a concept node 1104 corresponding to the third-party webpage or resource and store edge 1106 in one or more data stores.

In particular embodiments, a pair of nodes in social graph 1100 may be connected to each other by one or more edges 1106. An edge 1106 connecting a pair of nodes may represent a relationship between the pair of nodes. In particular embodiments, an edge 1106 may include or represent one or more data objects or attributes corresponding to the relationship between a pair of nodes. As an example, and not by way of limitation, a first user may indicate that a second user is a “friend” of the first user. In response to this indication, social networking system 1002 may send a “friend request” to the second user. If the second user confirms the “friend request,” social networking system 1002 may create an edge 1106 connecting the first user's user node 1102 to the second user's user node 1102 in social graph 1100 and store edge 1106 as social-graph information in one or more of data stores. In the example of FIG. 11, social graph 1100 includes an edge 1106 indicating a friend relation between user nodes 1102 of user “A” and user “B” and an edge indicating a friend relation between user nodes 1102 of user “C” and user “B.” Although this disclosure describes or illustrates particular edges 1106 with particular attributes connecting particular user nodes 1102, this disclosure contemplates any suitable edges 1106 with any suitable attributes connecting user nodes 1102. As an example, and not by way of limitation, an edge 1106 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1100 by one or more edges 1106.

In particular embodiments, an edge 1106 between a user node 1102 and a concept node 1104 may represent a particular action or activity performed by a user associated with user node 1102 toward a concept associated with a concept node 1104. As an example, and not by way of limitation, as illustrated in FIG. 11, a user may “like,” “attended,” “played,” “listened,” “cooked,” “worked at,” or “watched” a concept, each of which may correspond to an edge type or subtype. A concept-profile page corresponding to a concept node 1104 may include, for example, a selectable “check in” icon (such as, for example, a clickable “check in” icon) or a selectable “add to favorites” icon. Similarly, after a user clicks these icons, social networking system 1002 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 1002 may create a “listened” edge 1106 and a “used” edge (as illustrated in FIG. 11) between user nodes 1102 corresponding to the user and concept nodes 1104 corresponding to the song and application to indicate that the user listened to the song and used the application. Moreover, social networking system 1002 may create a “played” edge 1106 (as illustrated in FIG. 11) between concept nodes 1104 corresponding to the song and the application to indicate that the particular song was played by the particular application. In this case, “played” edge 1106 corresponds to an action performed by an external application (SPOTIFY) on an external audio file (the song “Imagine”). Although this disclosure describes particular edges 1106 with particular attributes connecting user nodes 1102 and concept nodes 1104, this disclosure contemplates any suitable edges 1106 with any suitable attributes connecting user nodes 1102 and concept nodes 1104. Moreover, although this disclosure describes edges between a user node 1102 and a concept node 1104 representing a single relationship, this disclosure contemplates edges between a user node 1102 and a concept node 1104 representing one or more relationships. As an example, and not by way of limitation, an edge 1106 may represent both that a user likes and has used at a particular concept. Alternatively, another edge 1106 may represent each type of relationship (or multiples of a single relationship) between a user node 1102 and a concept node 1104 (as illustrated in FIG. 11 between user node 1102 for user “E” and concept node 1104 for “SPOTIFY”).

In particular embodiments, social networking system 1002 may create an edge 1106 between a user node 1102 and a concept node 1104 in social graph 1100. As an example and not by way of limitation, a user viewing a concept-profile page (such as, for example, by using a web browser or a special-purpose application hosted by the user's client device 1006) may indicate that he or she likes the concept represented by the concept node 1104 by clicking or selecting a “Like” icon, which may cause the user's client device 1006 to send to social networking system 1002 a message indicating the user's liking of the concept associated with the concept-profile page. In response to the message, social networking system 1002 may create an edge 1106 between user node 1102 associated with the user and concept node 1104, as illustrated by “like” edge 1106 between the user and concept node 1104. In particular embodiments, social networking system 1002 may store an edge 1106 in one or more data stores. In particular embodiments, an edge 1106 may be automatically formed by social networking system 1002 in response to a particular user action. As an example, and not by way of limitation, if a first user uploads a picture, watches a movie, or listens to a song, an edge 1106 may be formed between user node 1102 corresponding to the first user and concept nodes 1104 corresponding to those concepts. Although this disclosure describes forming particular edges 1106 in particular manners, this disclosure contemplates forming any suitable edges 1106 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on social networking system 1002). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example, and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 1002 may execute or modify a particular action of the user.

An advertisement may also include social-networking-system functionality that a user may interact with. As an example, and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 1002) or RSVP (e.g., through social networking system 1002) to an event associated with the advertisement. In addition, or as an alternative, an advertisement may include social-networking-system context directed to the user. As an example, and not by way of limitation, an advertisement may display information about a friend of the user within social networking system 1002 who has taken an action associated with the subject matter of the advertisement.

In particular embodiments, social networking system 1002 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 1002 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 1002 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example, and not by way of limitation, particular user actions may be assigned both a rating and a weight while a relationship associated with the particular user action is assigned a rating and a correlating weight (e.g., so the weights total 250%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 1002 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example, and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 1002 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 1002 may calculate a coefficient based on a user's actions. Social networking system 1002 may monitor such actions on the online social network, on a third-party system 1008, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 1002 may calculate a coefficient based on the user's actions with particular types of content. The content may be associated with the online social network, a third-party system 1008, or another suitable system. The content may include users, profile pages, posts, news stories, headlines, instant messages, chat room conversations, emails, advertisements, pictures, video, music, other suitable objects, or any combination thereof. Social networking system 1002 may analyze a user's actions to determine whether one or more of the actions indicate an affinity for subject matter, content, other users, and so forth. As an example, and not by way of limitation, if a user may make frequently posts content related to “coffee” or variants thereof, social networking system 1002 may determine the user has a high coefficient with respect to the concept “coffee.” Particular actions or types of actions may be assigned a higher weight and/or rating than other actions, which may affect the overall calculated coefficient. As an example, and not by way of limitation, if a first user emails a second user, the weight or the rating for the action may be higher than if the first user simply views the user-profile page for the second user.

In particular embodiments, social networking system 1002 may calculate a coefficient based on the type of relationship between particular objects. Referencing the social graph 1100, social networking system 1002 may analyze the number and/or type of edges 1106 connecting particular user nodes 1102 and concept nodes 1104 when calculating a coefficient. As an example, and not by way of limitation, user nodes 1102 that are connected by a spouse-type edge (representing that the two users are married) may be assigned a higher coefficient than a user nodes 1102 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example, and not by way of limitation, if a user is tagged in first photo, but merely likes a second photo, social networking system 1002 may determine that the user has a higher coefficient with respect to the first photo than the second photo because having a tagged-in-type relationship with content may be assigned a higher weight and/or rating than having a like-type relationship with content. In particular embodiments, social networking system 1002 may calculate a coefficient for a first user based on the relationship one or more second users have with a particular object. In other words, the connections and coefficients other users have with an object may affect the first user's coefficient for the object. As an example, and not by way of limitation, if a first user is connected to or has a high coefficient for one or more second users, and those second users are connected to or have a high coefficient for a particular object, social networking system 1002 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 1100. As an example, and not by way of limitation, social-graph entities that are closer in the social graph 1100 (i.e., fewer degrees of separation) may have a higher coefficient than entities that are further apart in the social graph 1100.

In particular embodiments, social networking system 1002 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 1006 of the user). A first user may be more interested in other users or concepts that are closer to the first user. As an example, and not by way of limitation, if a user is one mile from an airport and two miles from a gas station, social networking system 1002 may determine that the user has a higher coefficient for the airport than the gas station based on the proximity of the airport to the user.

In particular embodiments, social networking system 1002 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 1002 may provide information that is relevant to user's interests and current circumstances, increasing the likelihood that they will find such information of interest. In particular embodiments, social networking system 1002 may generate content based on coefficient information. Content objects may be provided or selected based on coefficients specific to a user. As an example, and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 1002 may generate search results based on coefficient information. Search results for a particular user may be scored or ranked based on the coefficient associated with the search results with respect to the querying user. As an example, and not by way of limitation, search results corresponding to objects with higher coefficients may be ranked higher on a search-results page than results corresponding to objects having lower coefficients.

In particular embodiments, social networking system 1002 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 1008 (e.g., via an API or other communication channel), or from another suitable system. In response to the request, social networking system 1002 may calculate the coefficient (or access the coefficient information if it has previously been calculated and stored). In particular embodiments, social networking system 1002 may measure an affinity with respect to a particular process. Different processes (both internal and external to the online social network) may request a coefficient for a particular object or set of objects. Social networking system 1002 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed Aug. 8, 2006, U.S. patent application Ser. No. 12/977,027, filed Dec. 22, 2010, U.S. patent application Ser. No. 12/978,265, filed Dec. 23, 2010, and U.S. patent application Ser. No. 13/632,869, field Oct. 1, 2012, each of which is incorporated by reference in their entirety.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example, and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example, and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example, and not by way of limitation, a particular concept node 1104 corresponding to a particular photo may have a privacy setting specifying that the photo may only be accessed by users tagged in the photo and their friends. In particular embodiments, privacy settings may allow users to opt in or opt out of having their actions logged by social networking system 1002 or shared with other systems (e.g., third-party system 1008). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 1002 may send a request to the data store for the object. The request may identify the user associated with the request and may only be sent to the user (or a client device 1006 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

We claim:

1. A method comprising:
delivering a sample digital content to a first plurality of sample users of a networking system without delivering the sample digital content to a second plurality of sample users of the networking system; and
generating a machine learning model that outputs a lift recall score for a given user with respect to a target digital content item, the given user having a corresponding set of user characteristics, wherein generating the machine learning model comprises:
analyzing a first plurality of poll responses from the first plurality of sample users of the networking system indicating whether the first plurality of sample users recall the sample digital content;
analyzing a second plurality of poll responses from the second plurality of sample users of the networking system indicating whether the second plurality of sample users recall the sample digital content; and
training the machine learning model to output a recall lift score for the given user associated with a probability of the given user recalling the target digital content item based on a difference between recall rates of the first plurality of recall responses with respect to the sample digital content and recall rates of the second plurality of recall responses with respect to the sample digital content.

2. The method of claim 1, wherein training the machine learning model to output the recall lift score for the given user comprises training a first machine learning model to generate a first predicted recall probability for the given user based on an assumption that the given user has been exposed to the sample digital content.

3. The method of claim 2, wherein training the machine learning model to output the recall lift score for the given user comprises training a second machine learning model to generate a second predicted recall probability for the given user based on an assumption that the given user has not been exposed to the sample digital content.

4. The method of claim 3, wherein training the machine learning model comprises jointly training the first machine learning model and the second machine learning model based on correlations between user characteristics of the first plurality of sample users and the second plurality of sampled users and associated differences between recall rates corresponding to the first plurality of sample users and recall rates corresponding to the second plurality of sample users.

5. The method of claim 1, further comprising:
identifying a target number of users;
applying the machine learning model to a plurality of users of the networking system to determine recall lift scores for the plurality of users corresponding to the target digital content item; and
identifying a group of co-users of the networking system associated with recall lift scores having a sum equal to the target number of users.

6. The method of claim 5, further comprising providing the target digital content item to the target number of users by providing the target digital content item to the identified group of co-users associated with recall lift scores having the sum equal to the target number of users.

7. The method of claim 5, wherein applying the machine learning model to the plurality of users of the networking system comprises, for each of the plurality of users:
identifying a first recall probability based on an assumption that the user has been exposed to the target digital content item;
identifying a second recall probability based on an assumption that the user has not been exposed to the target digital content item; and
determining a recall lift score for the user based on a difference between the first recall probability and the second recall probability.

8. The method of claim 7, further comprising, for each of the plurality of users, identifying user characteristics comprising one or more of: user profile characteristics, a history of impression actions with respect to previously viewed digital content, and one or more tracked interactions with respect to the target digital content item.

9. The method of claim 1, wherein generating the machine learning model comprises:
leveraging a third-party machine learning model to identify a set of target user characteristics having a correlation to recall lift scores of users with respect to corresponding digital content; and
training the machine learning model to output the recall lift score for the given user based on the identified set of target characteristics for the given user, the identified set of target user characteristics comprising a subset of the set of user characteristics.

10. A system comprising:
at least one processor; and
at least one non-transitory computer readable storage medium storing instructions thereon that, when executed by the at least one processor, cause the system to:
deliver a sample digital content to a first plurality of sample users of a networking system without delivering the sample digital content to a second plurality of sample users of the networking system; and
generate a machine learning model that outputs a lift recall score for a given user with respect to a target digital content item, the given user having a corresponding set of user characteristics, wherein generating the machine learning model comprises:
analyzing a first plurality of poll responses from the first plurality of sample users of the networking system indicating whether the first plurality of sample users recall the sample digital content;
analyzing a second plurality of poll responses from the second plurality of sample users of the networking system indicating whether the second plurality of sample users recall the sample digital content; and
training the machine learning model to output a recall lift score for the given user associated with a probability of the given user recalling the target digital content item based on a difference between recall rates of the first plurality of recall responses with respect to the sample digital content and recall rates of the second plurality of recall responses with respect to the sample digital content.

11. The system of claim 10, wherein training the machine learning model to output a recall lift score for the given user comprises:
training a first machine learning model to generate a first predicted recall probability for the given user based on an assumption that the given user has been exposed to the sample digital content; and
training a second machine learning model to generate a second predicted recall probability for the given user based on an assumption that the given user has not been exposed to the sample digital content.

12. The system of claim 11, wherein training the machine learning model comprises jointly training the first machine learning model and the second machine learning model based on correlations between user characteristics of the first plurality of sample users and the second plurality of sampled users and associated differences between recall rates corresponding to the first plurality of sample users and recall rates corresponding to the second plurality of sample users.

13. The system of claim 10, wherein the instructions cause the system to:
identify a target number of users;
apply the machine learning model to a plurality of users of the networking system to determine recall lift scores for the plurality of users corresponding to the target digital content item;
identify a group of co-users of the networking system associated with recall lift scores having a sum equal to the target number of users; and
provide the target digital content item to the target number of users by providing the target digital content item to the identified group of co-users associated with recall lift scores having the sum equal to the target number of users.

14. The system of claim 13, wherein applying the machine learning model to the plurality of users of the networking system comprises, for each of the plurality of users:
identifying a first recall probability based on an assumption that the user has been exposed to the target digital content item;
identifying a second recall probability based on an assumption that the user has not been exposed to the target digital content item; and
determining a recall lift score for the user based on a difference between the first recall probability and the second recall probability.

15. The system of claim 10, wherein generating the machine learning model comprises:
leveraging a third-party machine learning model to identify a set of target user characteristics having a correlation to recall lift scores of users with respect to corresponding digital content; and
training the machine learning model to output the recall lift score for the given user based on the identified set of target characteristics for the given user, the identified set of target user characteristics comprising a subset of the set of user characteristics.

16. A non-transitory computer readable storage medium storing instructions thereon that, when executed by at least one processor, cause a computer system to:
deliver a sample digital content to a first plurality of sample users of a networking system without delivering the sample digital content to a second plurality of sample users of the networking system; and
generate a machine learning model that outputs a lift recall score for a given user with respect to a target digital content item, the given user having a corresponding set of user characteristics, wherein generating the machine learning model comprises:
analyzing a first plurality of poll responses from the first plurality of sample users of the networking system indicating whether the first plurality of sample users recall the sample digital content;
analyzing a second plurality of poll responses from the second plurality of sample users of the networking system indicating whether the second plurality of sample users recall the sample digital content; and
training the machine learning model to output a recall lift score for the given user associated with a probability of the given user recalling the target digital content item based on a difference between recall rates of the first plurality of recall responses with respect to the sample digital content and recall rates of the second plurality of recall responses with respect to the sample digital content.

17. The non-transitory computer readable storage medium of claim 16, wherein training the machine learning model to output a recall lift score for the given user comprises:
training a first machine learning model to generate a first predicted recall probability for the given user based on an assumption that the given user has been exposed to the sample digital content; and
training a second machine learning model to generate a second predicted recall probability for the given user based on an assumption that the given user has not been exposed to the sample digital content.

18. The non-transitory computer readable storage medium of claim 17, training the machine learning model comprises jointly training the first machine learning model and the second machine learning model based on correlations between user characteristics of the first plurality of sample users and the second plurality of sampled users and associated differences between recall rates corresponding to the first plurality of sample users and recall rates corresponding to the second plurality of sample users.

19. The non-transitory computer readable storage medium of claim 16, wherein the instructions cause the computer system to:
identify a target number of users;
apply the machine learning model to a plurality of users of the networking system to determine recall lift scores for the plurality of users corresponding to the target digital content item;
identify a group of co-users of the networking system associated with recall lift scores having a sum equal to the target number of users; and
provide the target digital content item to the target number of users by providing the target digital content item to the identified group of co-users associated with recall lift scores having the sum equal to the target number of users.

20. The non-transitory computer readable storage medium of claim 16, wherein generating the machine learning model comprises:
leveraging a third-party machine learning model to identify a set of target user characteristics having a correlation to recall lift scores of users with respect to corresponding digital content; and
training the machine learning model to output the recall lift score for the given user based on the identified set of target characteristics for the given user, the identified set of target user characteristics comprising a subset of the set of user characteristics.
